(19) United States
(12) Patent Application Publication
(10) Pub. No.: US 2026/0116755 A1
(43) Pub. Date: Apr. 30, 2026

(54) METHOD FOR RECOVERING HIGH-EFFICIENCY LITHIUM FROM LOW-CONCENTRATION LITHIUM WASTE LIQUID AND LITHIUM CARBONATE PRODUCED THEREBY

(71) Applicant: Korea Institute Of Geoscience And Mineral Resources, Daejeon (KR)

(72) Inventors: Tae-Gong RYU, Daejeon (KR); Jun-Ho SHIN, Daejeon (KR); Jae-Min JEONG, Daejeon (KR)

(73) Assignee: Korea Institute Of Geoscience And Mineral Resources, Daejeon (KR)

(21) Appl. No.: 19/145,145

(22) PCT Filed: Dec. 28, 2023
(86) PCT No.: PCT/KR2023/021825

§ 371 Date: Jul. 1, 2025

(30) Foreign Application Priority Data
Jan. 3, 2023 (KR) 10-2023-0000508

(51) Int. Cl. C01B 25/30; C01D 15/06; C01D 15/08; C22B 26/12; C25C 1/02

(52) U.S. Cl. CPC C01B 25/301; C01D 15/06; C01D 15/08; C22B 26/12; C25C 1/02; C01P 2002/72

(57) ABSTRACT

The present invention provides a method for recovering high-efficiency lithium from a low-concentration lithium waste liquid, and lithium carbonate produced thereby, the method comprising the steps of: adsorbing lithium-containing metal ions from a lithium waste liquid onto an electrode in an electric adsorption system, and desorbing the metal ions adsorbed on the electrode with a desorption solution (S10); preparing an insoluble lithium compound by adding an aluminum source to the desorption solution (S20); preparing a leachate by acid leaching or roasting/water leaching of the insoluble lithium compound (S30); and producing at least one of lithium phosphate, liquid sulfate, and lithium carbonate from the leachate.

### TECHNICAL FIELD

The present disclosure relates to a method for recovering lithium from a low-concentration lithium waste liquid. In particular, the present disclosure relates to a method for recovering lithium by improving the process and deriving optimal process conditions through steps including electroadsorption, conversion to an insoluble lithium compound, leaching, concentration, and purification of the lithium waste liquid containing a small amount of lithium. This enables lithium recovery from low-concentration lithium waste liquids that were previously treated as wastewater due to low economic feasibility.

### BACKGROUND ART

As the markets for electric vehicles (EVs) and energy storage systems (ESS) are rapidly expanding, the demand for lithium compounds used as raw materials for cathode materials in lithium-ion batteries is also surging.

Commercially viable lithium resources are limited to high-grade minerals and brine lakes, and recently, the need to develop recovery technologies for low-grade lithium resources has been increasing.

Conventionally, due to the low concentration of lithium ions, it has been economically unfeasible to apply previously developed non-evaporative lithium extraction technologies such as adsorption, precipitation, and solvent extraction. As a result, low-concentration lithium waste liquids are currently treated as wastewater.

Among the known lithium ion recovery technologies, the most common methods include the use of lithium ion adsorbents, precipitation, and solvent extraction.

In the case of precipitation and solvent extraction, pretreatment processes to separate impurity ions are essential, and excessive amounts of precipitants and pH adjustment of the solution are required when recovering low-concentration lithium ions.

Although it is possible to apply precipitation methods that convert lithium ions into poorly soluble lithium compounds, this approach also necessitates the use of a large amount of precipitants and pH adjustment of the solution, which poses operational difficulties.

Meanwhile, in the case of adsorption methods for lithium ion recovery, repeated adsorption and desorption processes are required to recover lithium ions from lithium waste liquids with low lithium concentrations.

However, depending on the characteristics of the solution, the adsorption capacity may decrease, resulting in low recovery efficiency.

Therefore, there is a demand for a high-efficiency and environmentally friendly lithium recovery technology that can suppress the excessive use of precipitants and significantly reduce the amount of alkaline agents used for pH control during the conversion process when recovering lithium ions from low-concentration lithium waste liquids.

### DISCLOSURE

### Technical Problem

In order to solve the aforementioned problems, the purpose of the present disclosure is to provide a high-efficiency lithium ion recovery method that enhances efficiency through electric adsorption when recovering lithium components from low-concentration lithium waste liquids with low lithium content, and that, through a series of processes to increase the concentration of lithium ions and produce lithium carbonate, optimizes process conditions to suppress the incorporation of impurities, reduce the use of precipitants, and significantly decrease the amount of alkaline agents required for pH adjustment.

The problems to be solved by the present disclosure are not limited to those mentioned above, and other issues not explicitly stated will be clearly understood by those skilled in the art from the following description.

### Technical Solution

In order to achieve the purpose, an aspect of the present disclosure provides a method for recovering high-efficiency lithium from a low-concentration lithium waste liquid, comprising: a step (S10) of adsorbing lithium-containing metal ions from a lithium waste liquid onto an electrode in an electric adsorption system, and desorbing the metal ions adsorbed on the electrode with a desorption solution; a step (S20) of preparing an insoluble lithium compound including Li—Al-LDH(LiAl₂(OH)₇·2H₂O) by adding an aluminum source to the desorption solution; a step (S30) of preparing a leachate by acid leaching or roasting/water leaching of the insoluble lithium compound; and a step (S40) of producing at least one selected from the group consisting of lithium phosphate, lithium sulfate, and lithium carbonate from the leachate.

In some exemplary embodiments, the lithium waste liquid may have a lithium content of 100 ppm or less.

In some exemplary embodiments, in step S10, the adsorption and the desorption may be performed in an alternating manner, once or 2 to 20 times repeatedly under a potential of 1 V to 2 V, and a residual solution remaining on the electrode may be removed between the adsorption and the desorption and after the desorption.

In some exemplary embodiments, the aluminum source may include at least one selected from the group consisting of aluminum, sodium aluminate, aluminum hydroxide, alumina, aluminum chloride, and aluminum sulfate.

In some exemplary embodiments, in step S20, the aluminum source may be added to the desorption solution and reacted such that a molar ratio of Al to Li ranges from 1 to 4, to precipitate the insoluble lithium compound.

In some exemplary embodiments, when the leachate is prepared by the acid leaching of the insoluble lithium compound, the insoluble lithium compound and a sulfuric acid solution may be mixed and reacted such that a solid-to-liquid ratio (g/L) of the insoluble lithium compound to the sulfuric acid solution ranges from 50 to 500, and a molar concentration of the sulfuric acid solution may range from 0.5 M to 5 M.

In some exemplary embodiments, when the leachate is prepared by the roasting/water leaching of the insoluble lithium compound, the roasting performed prior to the water leaching may be sulfuric acid roasting or salt roasting.

In some exemplary embodiments, when the sulfuric acid roasting is performed, the insoluble lithium compound and a sulfuric acid solution may be mixed such that a solid-to-liquid ratio (g/L) of the insoluble lithium compound to the sulfuric acid solution ranges from 100 to 2000, and reacted at a temperature of 200° C. to 400° C. for 30 minutes to 2 hours to produce a sulfuric acid roasting conversion product. A molar concentration of the sulfuric acid solution may range from 1 M to 5 M.

In some exemplary embodiments, the sulfuric acid roasting conversion product may be heat-treated at a temperature of 600° C. to 1000° C. for 1 hour to 5 hours prior to the water leaching.

In some exemplary embodiments, when the salt roasting is performed, at least one reactant selected from the group consisting of chlorides (Me-Cl) and sulfates (Me-SO₄) may be mixed with the insoluble lithium compound,
when a chloride is used as the reactant, a molar ratio of Li to Cl may be adjusted to range from 0.5 to 1.5,
when a sulfate is used as the reactant, a molar ratio of Li to SO₄ may be adjusted to range from 1.6 to 2.5, and
the reactant mixed with the insoluble lithium compound may be reacted at a temperature of 500° C. to 900° C. for 3 hours to 5 hours.

In some exemplary embodiments, the water leaching may be performed once or 2 to 10 times repeatedly.

In some exemplary embodiments, step S40 may include: a step (S41) of producing lithium phosphate from the leachate; a step (S42) of producing a lithium sulfate solution from the lithium phosphate; and a step (S43) of producing lithium carbonate from the lithium sulfate solution.

In some exemplary embodiments, in step S41, a phosphate source and a sodium source may be added to the leachate such that a molar ratio of Li to PO₄ ranges from 2 to 4 and a molar ratio of Na to PO₄ ranges from 2 to 4, and the leachate mixed with the phosphate source and the sodium source may be reacted for 4 hours to 30 hours.

In some exemplary embodiments, in step S42, the lithium phosphate may be mixed with a sulfate (Me-SO₄) solution dissolved in distilled water and reacted such that a molar ratio of Li to SO₄ ranges from 1 to 3 and a solid-to-liquid ratio (g/L) of the lithium phosphate to the sulfate solution ranges from 80 to 320, to produce the lithium sulfate solution.

In some exemplary embodiments, the sulfate may include at least one selected from the group consisting of MgSO₄, (NH₄)₂SO₄, and Al₂(SO₄)₃.

In some exemplary embodiments, step S43 may include: a step of removing impurities by adding an alkaline agent to the lithium sulfate solution; and a step of producing the lithium carbonate by adding a carbonate source to the lithium sulfate solution from which the impurities have been removed.

In some exemplary embodiments, in the step of removing impurities by adding an alkaline agent to the lithium sulfate solution, calcium hydroxide may be added to the lithium sulfate solution to precipitate and remove aluminum, and sodium hydroxide may be added to adjust the pH to 11 or higher to remove calcium ions.

In some exemplary embodiments, in the step of producing the lithium carbonate by adding a carbonate source to the lithium sulfate solution from which the impurities have been removed, the carbonate source may be added such that a molar ratio of Li to CO₃ ranges from 1.5 to 2.5, and the lithium carbonate may be precipitated by stirring the mixture at a temperature of 40° C. to 90° C. for 1 hour to 24 hours.

In some exemplary embodiments, the carbonate source may include at least one selected from the group consisting of sodium carbonate (Na₂CO₃), sodium bicarbonate (NaHCO₃), potassium carbonate (K₂CO₃), potassium bicarbonate (KHCO₃), calcium carbonate (CaCO₃), magnesium carbonate (MgCO₃), and barium carbonate (BaCO₃).

In order to achieve the purpose, another aspect of the present disclosure provides lithium carbonate produced by the method of claim 1.

### Advantageous Effects

The method for recovering high-efficiency lithium from a low-concentration lithium waste liquid according to the present disclosure enables the recovery of lithium ions, which are valuable metals, from low-concentration lithium waste liquids that have conventionally been treated as wastewater, and provides a high-efficiency lithium recovery technology that is environmentally friendly by reducing the use of precipitants and alkaline agents.

### DESCRIPTION OF DRAWINGS

FIG. 1 is a process flow chart illustrating a method for recovering high-efficiency lithium from a low-concentration lithium waste liquid according to an exemplary embodiment of the present disclosure.

FIG. 2 is a graph showing the lithium ion adsorption capacity according to the reaction time of the adsorbent in an exemplary embodiment of the present disclosure.

FIG. 3 is a graph showing the ion concentration distribution in the lithium waste liquid according to the reaction time of the adsorbent for (a) LiMn₂O₄ and (b) Li_{1.33}Mn_{1.67}O₄ in an exemplary embodiment of the present disclosure.

FIG. 4 is a graph showing (a) the residual lithium ion concentration, and (b) the lithium ion adsorption capacity and pH change of the solution according to the amount of adsorbent added, in an exemplary embodiment of the present disclosure.

FIG. 5 is a graph showing (a) the residual lithium ion concentration, (b) the lithium adsorption capacity, and the final solution pH after the adsorption reaction according to the initial pH of the lithium waste liquid in an exemplary embodiment of the present disclosure.

FIG. 6 is a graph showing (a) the residual ion content, (b) the lithium ion recovery rate, and the effect on solution pH according to the amount of sodium aluminate added in an exemplary embodiment of the present disclosure.

FIGS. 7 and 8 are graphs showing the effects of the initial lithium ion concentration on the residual lithium ion concentration, lithium ion recovery rate, and solution pH in exemplary embodiments of the present disclosure.

FIG. 9 is a graph showing the change in conductivity of the lithium waste liquid and the desorption solution according to the number of electric adsorption/desorption cycles in an exemplary embodiment of the present disclosure.

FIG. 10 is a graph showing the change in lithium concentration in the lithium waste liquid and the desorption solution according to the number of electric adsorption/desorption cycles in an exemplary embodiment of the present disclosure.

FIG. 11 is a graph showing the ion concentration distribution and lithium ion leaching rate according to the molar concentration of sulfuric acid during room-temperature sulfuric acid leaching of Li—Al LDH in an exemplary embodiment of the present disclosure.

FIG. 12 is a graph showing the ion concentration distribution and lithium ion leaching rate according to the molar concentration of sulfuric acid during 80° C. sulfuric acid leaching of Li—Al LDH in an exemplary embodiment of the present disclosure.

FIG. 13a is a graph showing the lithium ion concentration distribution in the leachate according to the sulfuric acid molar concentration and solid-to-liquid ratio during 80° C. sulfuric acid leaching of Li—Al LDH in an exemplary embodiment of the present disclosure.

FIG. 13b is a graph showing the lithium ion leaching rate (%) according to the sulfuric acid molar concentration and solid-to-liquid ratio during 80° C. sulfuric acid leaching of Li—Al LDH in an exemplary embodiment of the present disclosure.

FIG. 13c is a graph showing the aluminum ion concentration distribution in the leachate according to the sulfuric acid molar concentration and solid-to-liquid ratio during 80° C. sulfuric acid leaching of Li—Al LDH in an exemplary embodiment of the present disclosure.

FIG. 14a is a graph showing the distribution of Li and Al contents in the filtrate according to the solid-to-liquid ratio (g/L) of Ca(OH)₂ to leachate in an exemplary embodiment of the present disclosure.

FIG. 14b is a graph showing the Li loss rate in the filtrate according to the solid-to-liquid ratio (g/L) of Ca(OH)₂ to leachate in an exemplary embodiment of the present disclosure.

FIG. 15 is a graph showing the ion concentration distribution and lithium ion recovery rate according to the sulfuric acid molar concentration during sulfuric acid roasting and water leaching reactions of Li—Al LDH in an exemplary embodiment of the present disclosure.

FIG. 16 shows the XRD patterns of the products (a) before and (b) after water leaching, according to the heat treatment temperature of the sulfuric acid roasting conversion product of Li—Al LDH in an exemplary embodiment of the present disclosure.

FIG. 17 is a graph showing the ion concentration distribution and lithium recovery rate after water leaching of the recovered products according to the heat treatment temperature of the sulfuric acid roasting conversion product of Li—Al LDH in an exemplary embodiment of the present disclosure.

FIG. 18a is a graph showing the ion concentration distribution in the solution and lithium recovery rate according to repeated water leaching of the sulfuric acid roasting (300° C., 1 h) conversion product of Li—Al LDH in an exemplary embodiment of the present disclosure.

FIG. 18b is a graph showing the ion concentration distribution in the solution and lithium recovery rate according to repeated water leaching of the sulfuric acid roasting (300° C., 1 h) and heat-treated (700° C., 4 h) conversion product of Li—Al LDH in an exemplary embodiment of the present disclosure.

FIG. 19 shows the XRD pattern of the product prepared from the lithium solution obtained after water leaching of the sulfuric acid roasting (300° C., 1 h; 700° C., 4 h) conversion product of Li—Al LDH in an exemplary embodiment of the present disclosure.

FIG. 20 is a graph showing the lithium ion concentration distribution in the lithium solution according to the solid-to-liquid ratio and Al/Li molar ratio during the wet conversion reaction of lithium phosphate and aluminum sulfate solution in an exemplary embodiment of the present disclosure.

FIG. 21 is a graph showing the removal efficiency (%) of residual Ca ions at different solution pH levels in the residual Ca ion removal step in an exemplary embodiment of the present disclosure.

FIG. 22 shows the XRD pattern of Li₂CO₃ prepared from the solution obtained by repeated water leaching of the sulfuric acid roasting conversion product of Li—Al LDH in an exemplary embodiment of the present disclosure.

### BEST MODE

In order to solve the aforementioned problems, the purpose of the present disclosure is to provide a high-efficiency lithium ion recovery method that enhances efficiency through electric adsorption when recovering lithium components from low-concentration lithium waste liquids with low lithium content, and that, through a series of processes to increase the concentration of lithium ions and produce lithium carbonate, optimizes process conditions to suppress the incorporation of impurities, reduce the use of precipitants, and significantly decrease the amount of alkaline agents required for pH adjustment.

### MODE FOR INVENTION

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail with reference to related drawings.

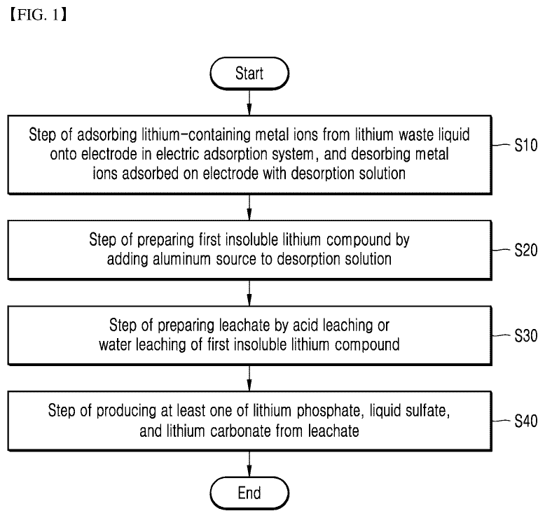

According to the present disclosure, as shown in the process flow chart of FIG. 1, a method for recovering high-efficiency lithium from a low-concentration lithium waste liquid is provided, the method comprising: a step (S10) of adsorbing lithium-containing metal ions from the lithium waste liquid onto an electrode in an electric adsorption system, and desorbing the metal ions adsorbed on the electrode with a desorption solution; a step (S20) of preparing an insoluble lithium compound by adding an aluminum source to the desorption solution; a step (S30) of preparing a leachate by acid leaching or roasting/water leaching of the insoluble lithium compound; and a step (S40) of producing at least one selected from the group consisting of lithium phosphate, lithium sulfate, and lithium carbonate from the leachate.

In an exemplary embodiment of the present disclosure, the lithium waste liquid may have a lithium content of 100 ppm or less, 70 ppm or less, or 10 to 50 ppm. Such low-concentration lithium waste liquid with a low lithium content has been treated as wastewater due to low economic feasibility, as previously developed non-evaporative lithium extraction technologies, such as adsorption, precipitation, and solvent extraction, require excessive amounts of precipitants, large quantities of alkaline agents for pH adjustment, and result in low recovery efficiency.

In response to this, the present disclosure aims to provide a high-efficiency and environmentally friendly lithium recovery technology capable of suppressing the excessive use of precipitants and significantly reducing the amount of alkaline agents required for pH adjustment during the conversion process when recovering lithium ions from low-concentration lithium waste liquids.

In an exemplary embodiment of the present disclosure, step S10 may be a step of adsorbing lithium ions using an electric adsorption system in order to efficiently separate low-concentration metal ions in the lithium waste liquid.

In step S10, the electric adsorption system may be configured with 2 to 500 sets, or 100 to 300 sets, of unit cells including carbon-based electrodes.

Each unit module (based on two sets) may have a lithium recovery capacity of 1 mg to 10 mg, or 2 mg to 5 mg.

The carbon-based electrodes may be made in various shapes and sizes using carbon materials conventionally used in anode fabrication, and the material, shape, and size are not particularly limited.

The unit module may have a structure of a negative electrode/cation exchange membrane (CEM)/spacer/anion exchange membrane (AEM)/positive electrode.

In step S10, the adsorption and desorption may be alternately performed once or 2 to 20 times under a potential of 0.5 V to 2 V, or 1 V to 1.5 V.

The adsorption and desorption may each be performed for 1 to 10 minutes, or 3 to 7 minutes.

During the adsorption and desorption, the lithium waste liquid and desorption solution may be supplied to the electric adsorption system using a metering pump (peristaltic pump). The desorption solution may be, for example, distilled water or the lithium waste liquid used in the electric adsorption step.

Residual solution remaining on the electrode between the adsorption and desorption and after the desorption may be removed. For example, after the adsorption process is completed, the residual solution inside may be removed by air blowing for 30 seconds to 2 minutes while maintaining the electric potential. Then, after performing the desorption process, the remaining desorption solution may be recovered by air blowing for 30 seconds to 2 minutes to enhance the recovery rate.

As such, by removing the residual solution from the electrode between the adsorption and desorption and after the desorption, lithium recovery efficiency can be improved and the number of adsorption/desorption cycles can be reduced.

In an exemplary embodiment of the present disclosure, step S20 may be a step of producing an insoluble lithium compound by adding an aluminum source to the desorption solution containing lithium-containing metal ions obtained through electric adsorption in step S10.

The lithium content in the desorption solution obtained through the electric adsorption may range from 500 ppm to 2000 ppm.

The aluminum source may include at least one selected from the group consisting of aluminum, sodium aluminate, aluminum hydroxide, alumina, aluminum chloride, and aluminum sulfate. In a specific example, the aluminum source may be sodium aluminate.

When sodium aluminate is mixed and reacted with the desorption solution, Li—Al LDH((LiAl₂(OH)₇·2H₂O) may be formed as the insoluble lithium compound.

In step S20, the aluminum source may be added to the desorption solution and reacted such that the molar ratio of Al to Li is 1 to 4, 1.5 to 3.5, or 2 to 3, to precipitate the insoluble lithium compound.

In an exemplary embodiment of the present disclosure, step S30 may be a step of preparing a leachate enriched with lithium ions by subjecting the insoluble lithium compound prepared in step S20 to acid leaching or roasting/water leaching.

In an exemplary embodiment of the present disclosure, when the leachate is prepared by acid leaching of the insoluble lithium compound, the leaching may be performed using a sulfuric acid solution having a molar concentration of 0.5 M to 5 M, 1.5 M to 4 M, or 2.5 M to 3.5 M.

In this case, the solid-to-liquid ratio (g/L) of the insoluble lithium compound to the sulfuric acid solution may be 50 to 500, 50 to 300, or 50 to 150.

In addition, the reaction temperature may be 40° C. to 90° C. or 60° C. to 80° C., and the reaction may be carried out for 1 to 12 hours or 2 to 6 hours.

When the leaching reaction is conducted using a sulfuric acid solution, a co-precipitation process using an alkaline agent may be performed to remove impurities.

Specifically, since aluminum impurities are excessively present in the leachate during sulfuric acid leaching, they must be removed in advance, as they lower purification efficiency in the subsequent lithium recovery process.

The alkaline agent may include at least one selected from the group consisting of sodium hydroxide, calcium hydroxide, and potassium hydroxide.

In a specific example, the alkaline agent may be calcium hydroxide, which may be more effective in removing aluminum from the leachate compared to sodium hydroxide.

In another exemplary embodiment of the present disclosure, when the leachate is prepared by roasting/water leaching of the insoluble lithium compound, the roasting performed prior to the water leaching may be sulfuric acid roasting or salt roasting.

First, in sulfuric acid roasting, the insoluble lithium compound and sulfuric acid solution may be mixed such that the solid-to-liquid ratio (g/L) of the insoluble lithium compound to the sulfuric acid solution is 100 to 2000, 500 to 1500, or 800 to 1200.

The sulfuric acid solution may have a molar concentration of 1 M to 5 M, 2 M to 5 M, or 2 M to 3 M.

The sulfuric acid roasting process may be performed at a temperature of 200° C. to 400° C. or 250° C. to 350° C. for 30 minutes to 2 hours or 50 minutes to 1 hour and 10 minutes to produce a sulfuric acid roasting conversion product.

The sulfuric acid roasting conversion product may then be heat-treated at 600° C. to 1000° C., 650° C. to 900° C., or 650° C. to 750° C. for 1 to 5 hours or 2 to 4 hours prior to water leaching.

By performing secondary heat treatment after sulfuric acid roasting, the incorporation of impurities, particularly aluminum, in the subsequent water leaching step can be prevented.

Next, in salt roasting, one or more reactants selected from chlorides (Me-Cl) and sulfates (Me-SO₄) may be mixed and reacted with the insoluble lithium compound to form a salt-roasting conversion product.

The chloride may include at least one selected from the group consisting of CaCl₂, AiCl₃, and MgCl₂. In a specific example, the chloride may be MgCl₂.

In this case, high lithium ion concentrations can be achieved during subsequent water leaching while suppressing the incorporation of aluminum ions.

When a chloride is used as the reactant, the molar ratio of Li to Cl may be adjusted to 0.5 to 1.5 or 0.8 to 1.2, and the salt roasting reaction may be performed at a temperature of 500° C. to 900° C., 500° C. to 750° C., or 650° C. to 750° C. for 3 to 5 hours.

The sulfate may include at least one selected from the group consisting of Al₂(SO₄)₃·xH₂O(x:14˜18), MgSO₄, and (NH₄)₂SO₄. In a specific example, the sulfate may be (NH₄)₂SO₄.

In this case, high lithium ion concentrations can be achieved during subsequent water leaching while suppressing the incorporation of aluminum ions.

When a sulfate is used as the reactant, the molar ratio of Li to SO₄ may be adjusted to 1.6 to 2.5 or 1.8 to 2.2, and the salt roasting reaction may be carried out at a temperature of 500° C. to 900° C., 500° C. to 800° C., or 650° C. to 750° C. for 3 to 5 hours.

After sulfuric acid roasting or salt roasting, the water leaching may be performed at a solid-to-liquid ratio (g/L) of 50 to 200 or 80 to 130 for 1 to 30 hours or for 4 to 12 hours.

The water leaching may be performed once, or 2 to 10 times, or 3 to 5 times repeatedly.

The lithium ion content in the resulting leachate may be 2000 ppm or higher.

In an exemplary embodiment of the present disclosure, step S40 may be a step of producing at least one selected from lithium phosphate, lithium sulfate, and lithium carbonate from the leachate.

In particular, step S40 may include: a step (S41) of producing lithium phosphate from the leachate; a step (S42) of producing a lithium sulfate solution from the lithium phosphate; and a step (S43) of producing lithium carbonate from the lithium sulfate solution.

In particular, the present disclosure provides lithium phosphate (Li₃PO₄) as an intermediate to convert the leachate with high lithium content and reduced impurity ions into a high-concentration lithium solution required for lithium carbonate production.

The lithium content of the insoluble lithium compound, Li—Al LDH, is 3.21% per gram, while that of lithium phosphate is approximately 17.98%, making lithium phosphate more suitable for producing high-concentration lithium solutions.

Meanwhile, although Li—Al LDH has a lower lithium content and specific gravity and is not suitable for high-concentration lithium solution production, it has a much lower solubility than lithium phosphate, making it appropriate for efficiently separating lithium ions from solutions with lithium concentrations below 1000 ppm.

This compound is then converted via a sulfation reaction into a solution with lithium ion concentration of 2000 ppm or more and used as a raw material for lithium phosphate production.

In an exemplary embodiment of the present disclosure, step S41 may be carried out by adding a phosphate source and a sodium source to the lithium-containing leachate such that such that a molar ratio of Li to PO₄ ranges from 2 to 4 and a molar ratio of Na to PO₄ ranges from 2 to 4, and reacting for 1 to 30 hours.

In a specific example, step S41 may be carried out by adding a phosphate source and a sodium source to the lithium-containing leachate such that such that a molar ratio of Li to PO₄ ranges from 2.5 to 3.5 and a molar ratio of Na to PO₄ ranges from 2.5 to 3.5, and reacting for 22 to 24 hours.

The phosphate source may include phosphoric acid (H₃PO₄) or phosphate salts. The phosphate salts may include one or more selected from the group consisting of potassium phosphate, sodium phosphate, aluminum phosphate, zinc phosphate, ammonium polyphosphate, and sodium hexametaphosphate. In a specific example, the phosphate source may be phosphoric acid (H₃PO₄).

The sodium source may include one or more selected from the group consisting of sodium hydroxide, sodium phosphate, and sodium hexametaphosphate. In a specific example, the sodium source may be sodium hydroxide.

In step S42, the lithium phosphate is mixed with a sulfate (Me-SO₄) solution dissolved in distilled water and reacted such that a molar ratio of Li to SO₄ ranges from 1 to 3 or 1.5 to 2.5 and a solid-to-liquid ratio (g/L) of the lithium phosphate to the sulfate solution ranges from 80 to 320, 80 to 200 or 90 to 110, to convert the mixture to the lithium sulfate solution.

This reaction of the lithium phosphate and the sulfate may be performed at 40° C. to 95° C. or 75° C. to 85° C. for 5 to 10 hours or 7 to 9 hours.

The sulfate compound may include one or more selected from the group consisting of MgSO₄, (NH₄)₂SO₄, and Al₂(SO₄)₃. In a specific example, the sulfate compound may be Al₂(SO₄)₃.

By producing a lithium sulfate solution from lithium phosphate through a substitution reaction using a sulfate compound in this manner, a lithium sulfate solution with a high lithium ion concentration can be obtained.

In order to prevent the evaporation of distilled water during the reaction of lithium phosphate and the sulfate compound, a reflux reactor may be used.

In this step S42, Al₂(SO₄)₃ may be dissolved in distilled water to adjust the Li/Al molar ratio to 0.317 to 0.367, 0.321 to 0.350, or 0.325 to 0.350, which allows production of a lithium sulfate solution with a high lithium ion concentration.

As a specific example, the highest lithium concentration may be achieved when the lithium phosphate/sulfate solution solid-to-liquid ratio (g/L) is 100 or 200 and the Al/Li ratio is 0.325 to 0.350, or when the solid-to-liquid ratio is 280 to 320 and the Al/Li ratio is 0.355 to 0.367.

The lithium ion concentration in the lithium sulfate solution produced as above may be 10,000 ppm or higher.

Step S43 may include: a step of removing impurities by adding an alkaline agent to the lithium sulfate solution; and a step of producing the lithium carbonate by adding a carbonate source to the lithium sulfate solution from which the impurities have been removed.

The alkaline agent may include one or more selected from the group consisting of sodium hydroxide, calcium hydroxide, and potassium hydroxide.

In one example, the step of removing impurities may be performed by adding calcium hydroxide to precipitate and remove aluminum, and then adding sodium hydroxide to adjust the pH to 11 or higher to remove calcium ions.

This allows additional impurity removal before lithium carbonate production, increasing the purity of the lithium carbonate.

The step of recovering lithium carbonate from the impurity-removed lithium sulfate solution may be performed by adding a carbonate source such that the Li/CO₃ molar ratio is 1.5 to 2.5, and stirring at 40° C. to 90° C. for 1 to 24 hours to precipitate lithium carbonate.

This can result in a high conversion yield from lithium sulfate to lithium carbonate.

The carbonate source may include one or more selected from the group consisting of sodium carbonate (Na₂CO₃), sodium bicarbonate (NaHCO₃), potassium carbonate (K₂CO₃), potassium bicarbonate (KHCO₃), calcium carbonate (CaCO₃), magnesium carbonate (MgCO₃), and barium carbonate (BaCO₃). In a specific example, the carbonate source may be sodium carbonate.

In an exemplary embodiment of the present disclosure, each step may be performed under stirring conditions. The stirring speed may be controlled to 100 rpm to 500 rpm, 200 rpm to 400 rpm, or 250 rpm to 350 rpm.

In addition, the present disclosure may provide at least one selected from the group consisting of lithium phosphate, lithium sulfate, and lithium carbonate, each of which is produced through the above-described method for recovering lithium from a low-concentration lithium waste liquid.

As described above, the method for recovering lithium from a low-concentration lithium waste liquid according to the present disclosure has been described and illustrated in the drawings. However, the descriptions and illustrations provided herein include only the essential components necessary for understanding the present disclosure. In addition to the processes and apparatuses described and illustrated, other processes and apparatuses not explicitly described or illustrated may be appropriately applied and utilized to implement the method and magnesium oxide produced by the method according to the present disclosure.

Hereinafter, exemplary embodiments will be described in detail to specifically explain the present disclosure. However, the exemplary embodiments according to the present disclosure may be modified in various forms, and the scope of the present disclosure should not be construed as being limited to the embodiments described below. The exemplary embodiments of the present disclosure are provided to more fully explain the present disclosure to those of ordinary skill in the art.

### PREPARATION EXAMPLES

A lithium waste solution generated from a domestic industrial company (Company K) was collected, and suspended solids were removed through filtration.

The separated lithium waste solution had a pH of approximately 7. The main cationic components contained in the lithium waste solution were lithium (Li, ˜70 ppm), sodium (Na, ˜43 ppm), and calcium (Ca, ˜39 ppm), and the main anionic component was chloride (Cl, ˜2320 ppm).

### Preparation Example 1: Adsorption Reaction Using Adsorbents

To recover low-concentration lithium ions contained in the lithium waste solution, adsorbents LiMn₂O₄ and Li_{1.33}Mn_{1.67}O₄ were used, respectively.

Prior to the adsorption experiment, lithium ions in the adsorbent structure were exchanged with hydrogen ions by performing a leaching reaction for 48 hours under the condition of 2 g of adsorbent per 1 L of 0.5 M HCl (leaching efficiency: >98%).

Based on 1 L of lithium waste solution, 3 g of adsorbent was used, and the adsorption reaction was conducted for 5 days. The filtrate was sampled and filtered at different reaction times, and the concentrations of components were analyzed using ICP (PerkinElmer 7300 DV). The results are shown in Tables 1 and 2 below.

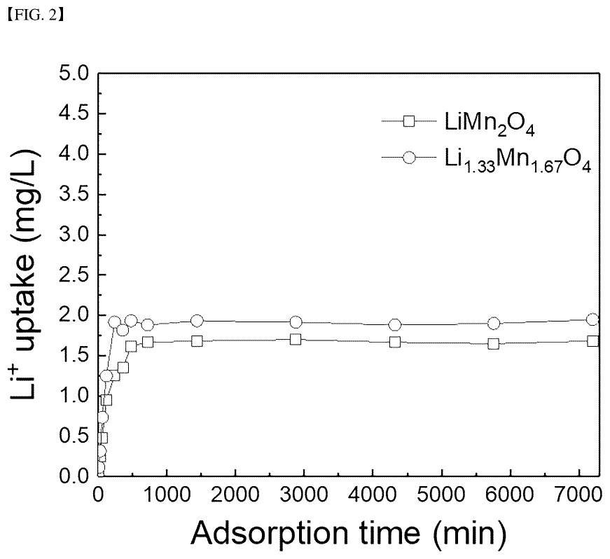

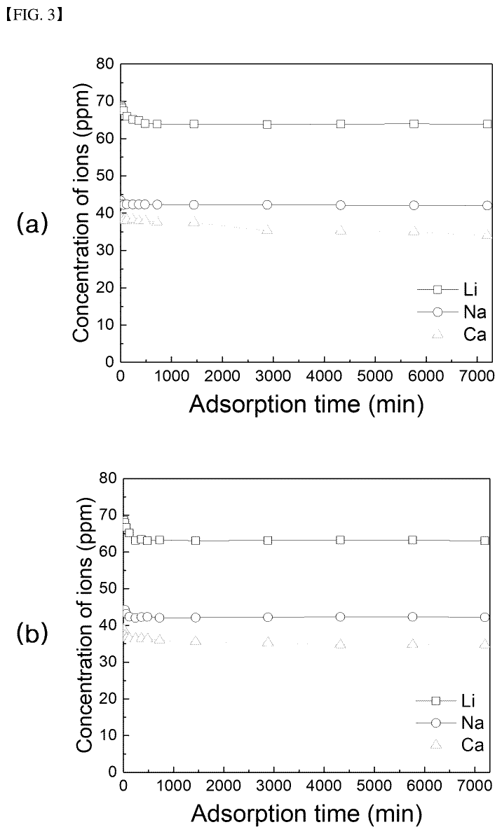

In addition, FIG. 2 illustrates the lithium ion adsorption capacity according to the reaction time with the adsorbents, and FIG. 3 shows the ionic concentration distribution in the lithium waste solution according to the reaction time of the adsorbent application: (a) for LiMn₂O₄, and (b) for Li_{1.33}Mn_{1.67}O₄.

From the experimental results, the time to reach adsorption equilibrium was observed to be within 12 hours, and the lithium ion adsorption capacity was observed to be approximately 1.6˜1.9 mg-Li/g-adsorbent.

TABLE 1

| | Reaction | | | | Li | Recovery |
|---|---|---|---|---|---|---|
| | time | Li | Na | Ca | uptake | efficiency |
| | (min) | (ppm) | (ppm) | (ppm) | (mg/g) | (%) |
| LiMn₂O₄ 3 g + | | 68.9 | 43.45 | 38.85 | | 0 |
| Lithium Waste | 10 | 68.65 | 42.3 | 38.55 | 0.08 | 0.36 |
| Solution 1 L | 30 | 68.15 | 42.45 | 38.2 | 0.25 | 1.09 |
| (Room Tempera- | 60 | 67.45 | 42.2 | 38.05 | 0.48 | 2.10 |
| ture, 300 RPM) | 120 | 66.05 | 42.4 | 38.15 | 0.95 | 4.14 |
| | 240 | 65.15 | 42.35 | 38.3 | 1.25 | 5.44 |
| | 360 | 64.85 | 42.35 | 37.95 | 1.35 | 5.88 |
| | 480 | 64.05 | 42.35 | 38 | 1.62 | 7.04 |
| | 720 | 63.9 | 42.3 | 37.6 | 1.67 | 7.26 |
| | 1440 | 63.85 | 42.25 | 37.55 | 1.68 | 7.33 |
| | 2880 | 63.8 | 42.25 | 35.35 | 1.70 | 7.40 |
| | 4320 | 63.9 | 42.15 | 35.3 | 1.67 | 7.26 |
| | 5760 | 63.95 | 42.1 | 35.05 | 1.65 | 7.18 |
| | 7200 | 63.85 | 42.05 | 34 | 1.68 | 7.33 |

TABLE 2

| | Reaction | | | | Li | Recovery |
|---|---|---|---|---|---|---|
| | time | Li | Na | Ca | uptake | efficiency |
| | (min) | (ppm) | (ppm) | (ppm) | (mg/g) | (%) |
| Li_{1.33}Mn_{1.67}O₄ 3 g + | | 68.9 | 43.45 | 38.85 | 0 | 0 |
| Lithium Waste | 10 | 68.55 | 43.95 | 38.9 | 0.12 | 0.51 |
| Solution 1 L | 30 | 67.95 | 44.3 | 37.3 | 0.32 | 1.38 |
| (Room Tempera- | 60 | 66.7 | 43.2 | 36.55 | 0.73 | 3.19 |
| ture, 300 RPM) | 120 | 65.15 | 42.4 | 36.5 | 1.25 | 5.44 |
| | 240 | 63.15 | 42.05 | 36.5 | 1.92 | 8.35 |
| | 360 | 63.45 | 42.3 | 36.5 | 1.82 | 7.91 |
| | 480 | 63.1 | 42.35 | 36.45 | 1.93 | 8.42 |
| | 720 | 63.25 | 42.1 | 36 | 1.88 | 8.20 |
| | 1440 | 63.1 | 42.15 | 35.6 | 1.93 | 8.42 |
| | 2880 | 63.15 | 42.25 | 35.35 | 1.92 | 8.35 |
| | 4320 | 63.25 | 42.35 | 34.8 | 1.88 | 8.20 |
| | 5760 | 63.2 | 42.35 | 34.85 | 1.90 | 8.27 |
| | 7200 | 63.05 | 42.25 | 34.8 | 1.95 | 8.49 |

The Li uptake was calculated using Equation 1 below, and the lithium ion recovery efficiency was calculated using Equation 2 below.

$$Li uptake ( mg / g ) = ( \frac{{C}_{t} - {C}_{0}}{m} ) \times V \qquad [ Equation 1 ]$$

C₀, Cₜ: Lithium ion concentrations (ppm) at the beginning and end of the reaction, respectively
V₀: Volume of the solution

$$Lithium ion recovery rate ( \% ) = ( 1 - \frac{{C}_{t} {V}_{t}}{{C}_{0} {V}_{0}} ) \times 100 \qquad [ Equation 2 ]$$

C₀, Cₜ: Lithium ion concentrations (ppm) at the beginning and end of the reaction, respectively
V₀, Vₜ: Volume of lithium solution at the beginning and end of the reaction (V)

### Preparation Example 2: Adsorption Reaction Based on Lithium Content/Adsorbent Ratio

In Preparation Example 1 above, the lithium adsorption performance was observed to be significantly lower than typical values for lithium adsorbents. Therefore, the adsorption experiment was conducted by adjusting the lithium content-to-adsorbent ratio in the lithium waste solution.

Using 150 mL of lithium waste solution as a basis, 0.05 to 1 g of adsorbent was used, and the adsorption reaction was carried out for 3 days at room temperature under stirring at 300 RPM. After the reaction, the filtrate was sampled and filtered, and the concentrations of the components were analyzed, as shown in Table 3.

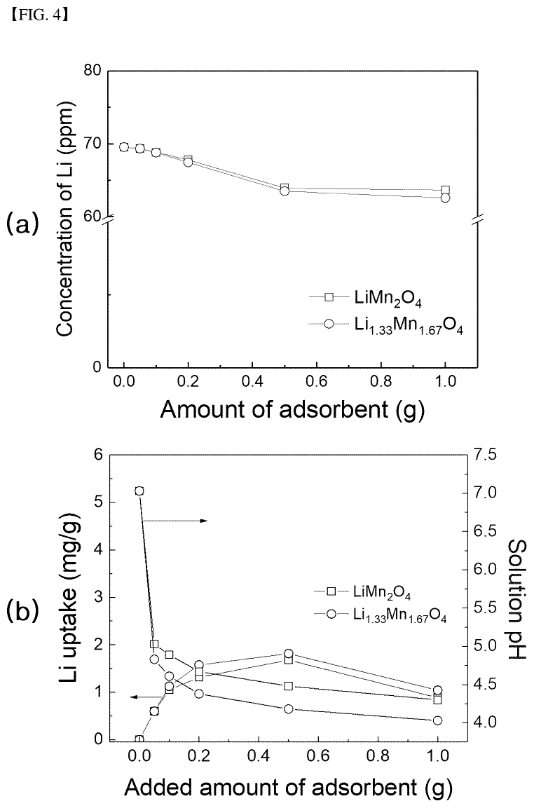

In addition, changes in (a) residual lithium ion concentration and (b) lithium ion uptake and solution pH according to the amount of adsorbent added can be seen in FIG. 4.

From the experimental results, lithium ion uptake was observed to be approximately 0.6˜1.8 mg-Li/g-adsorbent, and the lithium ion recovery efficiency was confirmed to be low, at approximately 0.29˜10%.

After the reaction, the initial solution pH of about 7 decreased to around 4 as the amount of adsorbent used increased. This is attributed to the ion exchange reaction between the H⁺ ions in the adsorbent structure and Li⁺ ions in the solution, resulting in an increase of H⁺ ions in the solution and, consequently, a decrease in pH. It was also confirmed that lower adsorption capacity was observed in the lower pH range during the adsorption reaction.

TABLE 3

| | Absorbent | | | | Li | | Li Ion |
|---|---|---|---|---|---|---|---|
| | Weight | Li | Na | Ca | uptake | | Recovery |
| Reactants | (g) | (ppm) | (ppm) | (ppm) | (mg/g) | pH | Rate (%) |
| Li_{1.33}Mn_{1.67}O₄ + | Initial | 69.55 | 42.55 | 38.65 | | 7.03 | |
| Lithium Waste | 0.05 | 69.35 | 41.2 | 37.75 | 0.60 | 4.83 | 0.29 |
| Solution 150 mL | 0.1 | 68.8 | 41.5 | 38.7 | 1.13 | 4.61 | 1.08 |
| | 0.2 | 67.45 | 42.05 | 38.4 | 1.58 | 4.38 | 3.02 |
| | 0.5 | 63.5 | 41.5 | 38.3 | 1.82 | 4.18 | 8.70 |
| | 1 | 62.6 | 41.65 | 38.4 | 1.04 | 4.03 | 9.99 |
| LiMn₂O₄ + | 0.05 | 69.35 | 41.95 | 38.25 | 0.60 | 5.03 | 0.29 |
| Lithium Waste | 0.1 | 68.85 | 41.75 | 38.6 | 1.05 | 4.89 | 1.01 |
| Solution 150 mL | 0.2 | 67.8 | 41.5 | 38.35 | 1.31 | 4.67 | 2.52 |
| | 0.5 | 63.95 | 41.5 | 38.05 | 1.68 | 4.48 | 8.05 |
| | 1 | 63.65 | 41.75 | 38.1 | 0.89 | 4.3 | 8.48 |

### Preparation Example 3: Adsorption Reaction Depending on the pH of Lithium Waste Solution

Based on 50 mL of lithium waste solution, NaOH was added to adjust the pH of the solution in the range of 7 to 13. Then, 0.15 g of the adsorbent was used to perform an adsorption reaction at room temperature under stirring at 300 RPM for 1 day. After the reaction, the filtrate was sampled/filtered and the concentrations of the components were analyzed. The results are shown in Table 4 below.

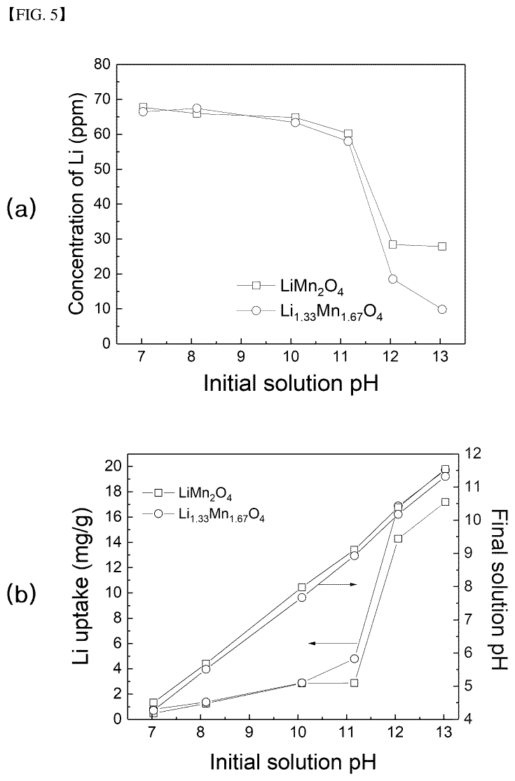

In addition, FIG. 5 shows (a) the residual lithium ion concentration and (b) lithium adsorption capacity and final solution pH after the adsorption reaction for each initial pH of the lithium waste solution.

According to the experimental results, the lithium ion adsorption capacity increased as the pH value of the lithium waste solution increased. At a pH of approximately 13, the lithium ion adsorption capacity was about 13 mg-Li/g-adsorbent for LiMn₂O₄ and about 19.7 mg-Li/g-adsorbent for Li_{1.33}Mn_{1.67}O₄. The lithium ion recovery efficiency was approximately 59.6% for LiMn₂O₄ and about 85.7% for Li_{1.33}Mn_{1.67}O₄.

In addition, it was confirmed that increasing the pH of the solution during the adsorption reaction led to an increase in lithium ion recovery efficiency. In the case of Ca ions, it was found that when the pH of the solution was increased above 12, the Ca ions were precipitated as Ca(OH)₂, allowing for separation before the adsorption reaction.

Furthermore, in the application of the adsorption reaction to low-concentration lithium waste solution, it was observed that the efficiency of the Li—H ion exchange reaction decreased due to the drop in pH during the adsorption process. This confirms that pH adjustment is essential during the adsorption reaction. It is presumed that the decrease in solution pH during the adsorption process is induced by anions such as Cl, SO₄, and CO₃, which are the major anionic constituents of the lithium waste solution.

TABLE 4

| | Absorbent | | | | Li | | Li Ion |
|---|---|---|---|---|---|---|---|
| | Weight | Li | Na | Ca | uptake | | Recovery |
| | (g) | (ppm) | (ppm) | (ppm) | (mg/g) | pH | Rate (%) |
| LiMn₂O₄ + | Initial | 69.15 | 54.9 | 35.58 | | | |
| Lithium Waste | 0.15 | 67.71 | 53.31 | 34.62 | 0.48 | 7.03 | 2.08 |
| Solution 50 mL | | 65.91 | 57.24 | 34.29 | 1.08 | 8.11 | 4.69 |
| | | 64.8 | 71.94 | 32.7 | 1.45 | 10.08 | 6.29 |
| | | 60.27 | 90.39 | 29.25 | 2.96 | 11.16 | 12.84 |
| | | 28.41 | 258.72 | 6.02 | 13.58 | 12.06 | 58.92 |
| | | 27.9 | | N.D. | 13.75 | 13.03 | 59.65 |
| Li_{1.33}Mn_{1.67}O₄ + | | 66.45 | 53.25 | 1.23*30 | 0.9 | 7.03 | 3.90 |
| Lithium Waste | | 67.41 | 57.51 | 36.27 | 0.58 | 8.11 | 2.52 |
| Solution 50 mL | | 63.33 | 68.7 | 33.51 | 1.94 | 10.08 | 8.42 |
| | | 57.99 | 89.1 | 32.64 | 3.72 | 11.16 | 16.14 |
| | | 18.51 | 237.99 | 13.11 | 16.88 | 12.06 | 73.23 |
| | | 9.87 | | N.D. | 19.76 | 13.03 | 85.73 |

### Preparation Example 4: Precipitation Reaction Depending on the Amount of Sodium Aluminate Added

To recover low-concentration lithium ions contained in lithium waste solution, sodium aluminate was used as a precipitant capable of converting lithium into a low-solubility Li—Al LDH (Layered Double Hydroxide, (LiAl₂(OH)₇·2H₂O)).

Based on 50 mL of waste solution, sodium aluminate powder was added while adjusting the Al/Li molar ratio in the range of 2 to 7. The precipitation reaction was carried out at room temperature for 24 hours under stirring at 300 RPM. After the reaction, the filtrate was sampled and filtered, and the concentrations of the components were analyzed.

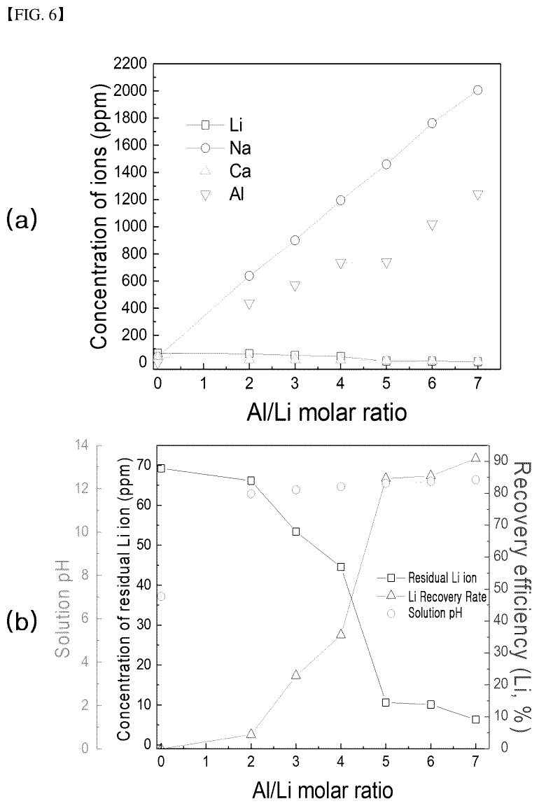

The results are shown in Table 5 below. In addition, FIG. 6 presents the effect of sodium aluminate dosage on (a) the concentration of residual ions and (b) lithium ion recovery efficiency and solution pH.

After the reaction, the concentrations of lithium and calcium ions in the filtrate decreased as the amount of sodium aluminate increased, while the concentrations of sodium and aluminum ions, which are components of the precipitant, increased.

According to the experimental results, the lithium ion recovery efficiency was approximately 4% when the Al/Li molar ratio was 2, and the lithium ion recovery efficiency increased to approximately 91% when the molar ratio was raised to 7. The pH of the solution, which was initially around 7, increased to approximately 12.3 as the Al/Li molar ratio increased up to 7.

The results of the precipitation reaction using sodium aluminate at various stoichiometric ratios targeting low-concentration lithium ions in lithium waste solution confirmed that the lithium ion recovery efficiency was initially low, and that an excess amount of precipitant was required to significantly improve the recovery efficiency.

TABLE 5

| | NaAlO₂ | Al/Li | | | | | Li | |
|---|---|---|---|---|---|---|---|---|
| | Dosage | molar | Li | Na | Ca | Al | Recovery | Solution |
| Condition | (g) | ratio | (ppm) | (ppm) | (ppm) | (ppm) | Rate (%) | pH |
| Lithium Waste | | Initial | 69.25 | 43.25 | 38.65 | — | | |
| Solution 50 mL + | 0.133 | 2 | 66.15 | 639 | 22.37 | 437.85 | 4.5 | 11.77 |
| NaAlO₂ | 0.199 | 3 | 53.4 | 900.5 | 21.7 | 570.5 | 22.9 | 11.96 |
| | 0.266 | 4 | 44.55 | 1195.5 | 18.8 | 736.5 | 35.7 | 12.1 |
| | 0.332 | 5 | 10.63 | 1460.5 | 15.25 | 741 | 84.6 | 12.25 |
| | 0.398 | 6 | 10.08 | 1763.5 | 12.15 | 1019.5 | 85.4 | 12.35 |
| | 0.465 | 7 | 6.33 | 2006.5 | 10.9 | 1243 | 90.9 | 12.42 |

### Preparation Example 5: Precipitation Reaction According to Lithium Ion Concentration

In Preparation Example 4, it was confirmed that the lithium ion recovery rate was low when a precipitation reaction using sodium aluminate was applied to a lithium waste solution containing low-concentration lithium ions.

Therefore, in order to analyze the recovery rate according to lithium ion concentration, model solutions (Li⁺ conc: 10-1000 ppm) were prepared using LiCl and LiOH, and applied to the precipitation reaction.

Based on 50 mL of LiCl solution, sodium aluminate powder was added at an Al/Li molar ratio of 2. The precipitation reaction was carried out at room temperature for 24 hours while stirring the mixture at 300 RPM. After the reaction, the filtrate was sampled and filtered, and the concentrations of the components were analyzed. The results are shown in Tables 6 and 7 below.

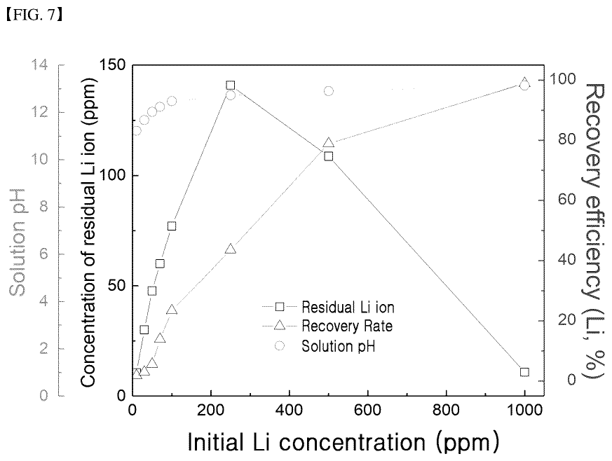

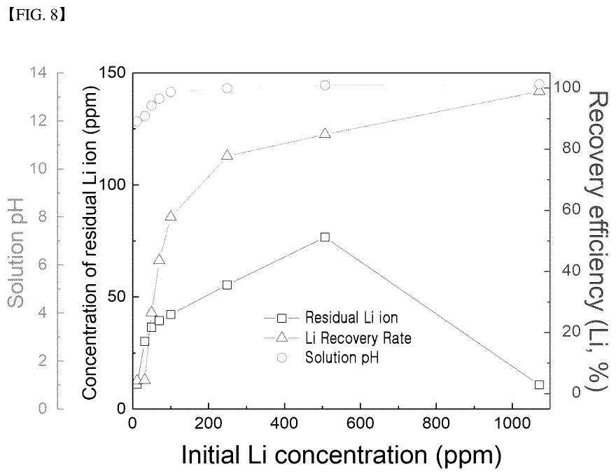

In addition, referring to FIG. 7 (LiCl) and FIG. 8 (LiOH), the residual lithium ion concentration, lithium ion recovery rate, and pH change of the solution according to the initial lithium ion concentration can be confirmed.

According to the experimental results, as the initial lithium ion concentration increased, the amount of residual lithium ions after the reaction also increased. The highest residual lithium ion concentration was observed at an initial concentration of 250 ppm. However, when the initial concentration increased beyond 250 ppm, the residual lithium ion concentration began to decrease.

It was also confirmed that the final pH of the solution increased as the initial concentration increased. This is presumed to be due to the increase in OH⁻ ions in the same volume of solution resulting from the increased amount of added precipitant component at a fixed Al/Li molar ratio.

TABLE 6

| | Al/Li | LiCl sol. | NaAlO₂ | | | | Li | |
|---|---|---|---|---|---|---|---|---|
| | molar | Li conc. | Dosage | Li | Na | Al | Recovery | |
| Condition | ratio | (ppm) | (g) | (ppm) | (ppm) | (ppm) | Rate (%) | pH |
| LiCl solution | 2 | 10 | 0.019 | 10.08 | 80.83 | 60.4 | 7.3 | 11.23 |
| 50 mL + | | 30 | 0.057 | 26.84 | 242.19 | 178.83 | 13.5 | 11.68 |
| NaAlO₂ | | 50 | 0.095 | 40.2 | 395.5 | 242.55 | 20.4 | 12.03 |
| | | 70 | 0.133 | 50.55 | 491.85 | 344.95 | 27.5 | 12.24 |
| | | 100 | 0.19 | 70.15 | 785 | 394.05 | 30.3 | 12.48 |
| | | 250 | 0.474 | 116.9 | 1937.1 | 311.2 | 53.2 | 12.73 |
| | | 500 | 0.948 | 112.6 | 3585 | 253.6 | 78.1 | 12.91 |
| | | 1000 | 1.897 | 10.45 | 7340 | 66.8 | 98.9 | 13.14 |

TABLE 7

| | Al/Li | LiOHl sol. | NaAlO₂ | | | | Li | |
|---|---|---|---|---|---|---|---|---|
| | molar | Li conc. | Dosage | Li | Na | Al | Recovery | |
| Condition | ratio | (ppm) | (g) | (ppm) | (ppm) | (ppm) | Rate (%) | pH |
| LiOH solution | 2 | 10 | 0.019 | 11.08 | 68.28 | 71.43 | 4.21 | 11.98 |
| 50 mL + | | 30 | 0.057 | 30.13 | 277.78 | 254.80 | 4.40 | 12.21 |
| NaAlO₂ | | 50 | 0.095 | 36.48 | 406.31 | 241.62 | 26.55 | 12.65 |
| | | 70 | 0.133 | 39.46 | 513.07 | 247.25 | 43.60 | 12.93 |
| | | 100 | 0.19 | 42.20 | 881.05 | 293.22 | 57.84 | 13.21 |
| | | 250 | 0.474 | 55.38 | 2186.07 | 265.68 | 77.75 | 13.36 |
| | | 500 | 0.948 | 76.65 | 4151.81 | 324.93 | 84.87 | 13.49 |
| | | 1000 | 1.897 | 10.74 | 8745.10 | 500.13 | 99.00 | 13.53 |

### EXEMPLARY EMBODIMENTS

### Exemplary Embodiment 1: Electro-Adsorption of Metal Ions in Lithium Waste Liquid

When the adsorption method using Li—Mn—O material and the precipitation method using sodium aluminate were applied to lithium waste liquid, a low lithium ion recovery rate was observed. This is attributed to the characteristics of the waste liquid, which has a low lithium ion concentration and a chloride-based composition, resulting in low efficiency when non-evaporative lithium extraction technologies are applied.

To address this, the present disclosure considered electro-adsorption technology for the efficient separation of low-concentration metal ions. An adsorption system including 10 cm×10 cm carbon electrodes was utilized to adsorb and separate metal ions.

For evaluating the adsorption performance through electro-adsorption, lithium waste liquid (Li⁺ concentration: 50 ppm) was prepared using LiCl. Adsorption/desorption experiments were conducted for 5 minutes each at an applied voltage of 1.4 V using a unit cell configured as (-electrode/CEM/spacer/AEM/+electrode). The recovery capacity was observed to be approximately 2 mg-Li per unit cell.

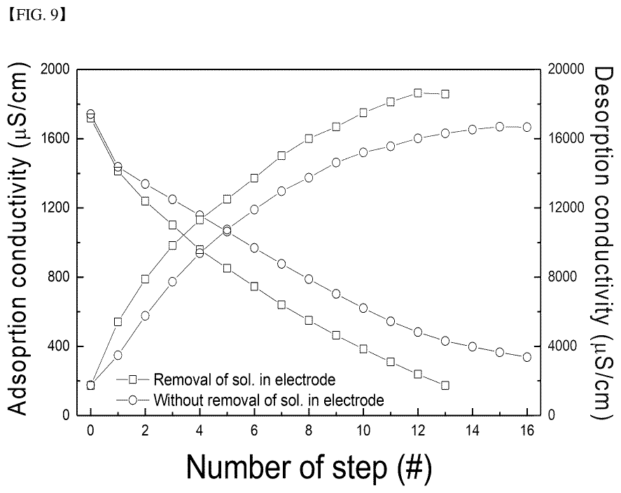

Based on 1 L of lithium waste liquid, an adsorption system consisting of three sets of unit cells was used. During repeated adsorption/desorption cycles, the conductivity of the lithium waste liquid and the recovered desorption solution was measured, as shown in FIG. 9.

During adsorption and desorption, the operation potential applied to the system was maintained at 1.4 V, and 50 mL of desorption solution was used to recover the adsorbed ions.

A peristaltic pump was used to supply the solution to the system at a flow rate of 100 mL/min for 5 minutes each during adsorption and desorption.

Referring to Table 8, it was observed that the concentration of metal ions in the desorption solution increased with the number of adsorption/desorption cycles. In addition, depending on whether air blowing was applied inside the electrodes to remove residual solvent, a difference of approximately 100 ppm in the lithium ion concentration of the recovered lithium waste liquid was confirmed.

TABLE 8

| | | Sample | Li | Na | Ca |
|---|---|---|---|---|---|
| Condition | Experimental Method | name | (ppm) | (ppm) | (ppm) |
| Unit cell 3ea | With solvent removal | Initial lithium | 69.05 | 42.05 | 38.65 |
| Adsorption/ | inside electrodes (O) | waste liquid | | | |
| Desorption | 13 cycles of | Final lithium | 14.22 | 9.35 | 1.75 |
| Potential: 1.4 V | adsorption/desorption | waste liquid | | | |
| Flow rate: 100 mL/min | | Desorption | 997 | 628 | 590.5 |
| | | solution | | | |
| | Without solvent removal | Initial lithium | 69.05 | 42.05 | 38.65 |
| | inside electrodes (X) | waste liquid | | | |
| | 16 cycles of | Final lithium | 23.7 | 13.17 | 2.71 |
| | adsorption/desorption | waste liquid | | | |
| | | Desorption | 889.5 | 557.5 | 470.5 |
| | | solution | | | |

### Exemplary Embodiment 2: Recovery of Metal Ions Using an Electric Adsorption System Comprising 200 Unit Cells

An electric adsorption system comprising 200 sets of unit cells was applied to a lithium waste liquid to analyze the ion recovery efficiency.

Specifically, adsorption and desorption experiments were carried out at a potential of 1.4 V for 5 minutes each. The lithium waste liquid and the desorption solution were supplied into the system at a flow rate of 2 L/min.

After adsorption, while maintaining the applied potential, air blowing was performed inside the electrode for approximately 1 minute to remove residual solvent and separate the ions. Subsequently, the desorption solution was introduced into the electrode to recover the adsorbed ions. After completion of desorption, air blowing was again performed for about 1 minute to collect the residual desorption solution and thereby improve the recovery efficiency.

The volumes of the lithium waste liquid and the desorption solution used for the electro-adsorption/desorption reaction were 8 L and 1 L, respectively.

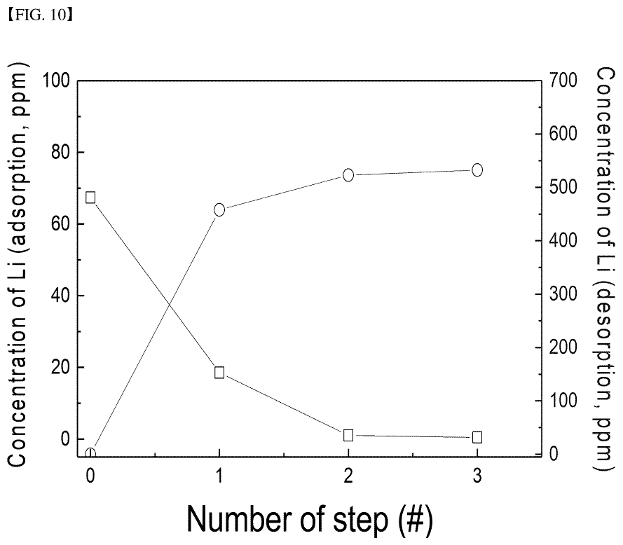

Referring to Table 9 and FIG. 10, it was confirmed from the experimental results that the ion recovery rate reached approximately 98% after two cycles. After three cycles, the discharged lithium waste liquid showed a lithium ion concentration of approximately 0.4 ppm, while the lithium ion concentration in the recovered desorption solution was approximately 532 ppm.

The pH of the recovered desorption solution containing the separated ions was approximately 12.1, and the pH of the lithium waste liquid after removal of the ions was approximately 6.3.

TABLE 9

| | # of | Sample | Li | |
|---|---|---|---|---|
| Condition | cycles | name | (ppm) | pH |
| Unit cell 200ea | Initial lithium waste liquid | | 67.4 | 6.9 |
| Adsorption/ | 1step | Lithium waste | 18.55 | |
| Desorption | | liquid | | |
| Potential: 1.4 V | | Desorption | 458 | |
| Flow rate: 2 L/min | | solution | | |
| | 2step | Lithium waste | 1.02 | |
| | | liquid | | |
| | | Desorption | 523 | |
| | | solution | | |
| | 3step | Lithium waste | 0.465 | 6.37 |
| | | liquid | | |
| | | Desorption | 532.5 | 12.16 |
| | | solution | | |

### Exemplary Embodiment 3: Lithium Ion Separation after Electric Adsorption

In order to separate lithium ions from the desorption solution in which lithium was concentrated by electric adsorption from lithium waste liquid, sodium aluminate was reacted to convert the lithium ions into Li—Al LDH.

Based on the lithium ion content in the desorption solution, sodium aluminate powder was added at an Al/Li molar ratio of 2 to 4, and the mixture was subjected to a precipitation reaction at room temperature for one day.

As shown in Table 10, the experimental results demonstrated a lithium recovery rate of approximately 66% at an Al/Li molar ratio of 2, and approximately 99% of lithium recovery rate when the Al/Li molar ratio was increased to 4.

Compared to the precipitation reaction results using lithium waste liquid and sodium aluminate, the residual lithium ion concentration after the precipitation reaction from the desorption solution was found to be lower. This confirms that a higher Al/Li ratio and alkaline pH conditions lead to higher recovery efficiency.

Meanwhile, the calcium contained in the desorption solution was found to be precipitated and separated as Ca(OH)₂ when the solution pH was increased to 12 or higher using NaOH.

In this experiment, trace amounts of residual calcium were not separately removed as Ca(OH)₂ during the pretreatment process, since it could be easily separated in a subsequent process for preparing a high-concentration lithium solution.

TABLE 10

| Condition | | | | | Li | |
|---|---|---|---|---|---|---|
| (Al/Li | Content (ppm) | | | | recovery | Solution |
| molar ratio) | Li | Na | Ca | Al | rate (%) | pH |
| Initial | 542 | 364.5 | 38.7 | | | 12.1 |
| 2 | 179.5 | 4825 | 3.195 | 350 | 66.8 | 13.1 |
| 2.5 | 58.2 | 6670 | 2.575 | 729.5 | 89.2 | 13.2 |
| 3 | 11.3 | 8250 | 2.75 | 1910.5 | 97.9 | 13.3 |
| 4 | 1.45 | 12030 | 1.67 | 5615 | 99.732 | 13.4 |

### Exemplary Embodiment 4: Conversion of Lithium into a Lithium Solution after Separation (Sulfuric Acid Leaching)

After separating lithium ions in the form of Li—Al LDH by reacting the desorption solution obtained through electric adsorption with sodium aluminate, the resulting Li—Al LDH was converted into a concentrated lithium solution.

The conversion from Li—Al LDH to lithium solution was conducted by leaching the Li—Al LDH using sulfuric acid solutions at concentrations ranging from 0.5 M to 2 M under room temperature and 80° C. conditions.

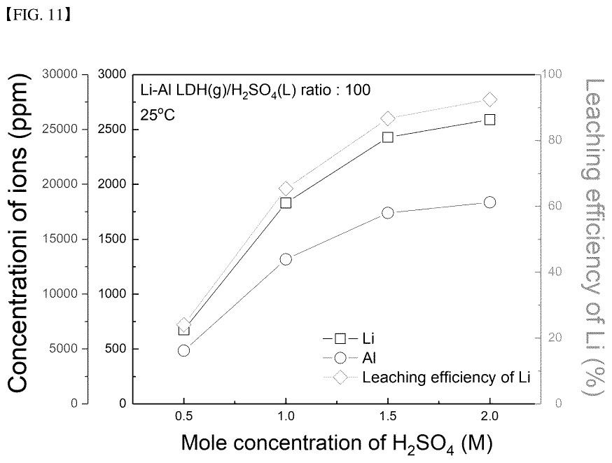

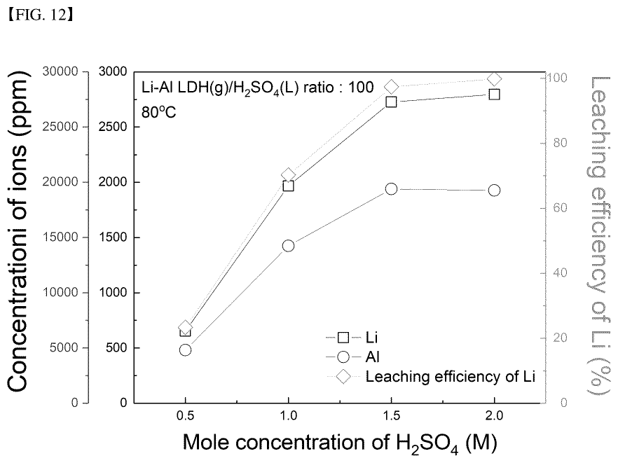

The experimental results are shown in Table 11, FIG. 11, and FIG. 12. FIG. 11 illustrates the ion concentration distribution and lithium leaching rate at room temperature (25° C.) according to the molarity of sulfuric acid. FIG. 12 shows the ion concentration distribution and lithium leaching rate at 80° C. according to the molarity of sulfuric acid.

According to the experimental results, under a solid (g) to liquid (L) ratio of 100 for the Li—Al LDH/sulfuric acid solution, a lithium recovery rate of over 90% was achieved when using sulfuric acid with a molarity of 2 M or higher at room temperature, and a lithium recovery rate of over 90% was achieved when using sulfuric acid with a molarity of 1.5 M or higher at 80° C.

TABLE 11
Li-Al LDH/Sulfuric Acid Leaching Experiment

| | Reaction | Stirring | Reaction | Sulfuric | | Li | | Al |
|---|---|---|---|---|---|---|---|---|
| Leaching | Temp. | Speed | Time | Acid conc. | Li conc. | Leaching | Al conc. | leaching |
| Condition | (° C.) | (RPM) | (h) | (M) | (ppm) | Rate (%) | (ppm) | Rate (%) |
| LDH 20 g + | Room | 300 | 12 | 0.5 | 674.42 | 24.09 | 4848.16 | 19.47 |
| H₂SO₄ 200 mL | Temperature | | | 1 | 1831.01 | 65.39 | 13171.77 | 52.90 |
| | | | | 1.5 | 2428.51 | 86.73 | 17399.37 | 69.88 |
| | | | | 2 | 2590.02 | 92.50 | 18362.49 | 73.74 |
| | 80 | | | 0.5 | 653.54 | 23.34 | 4808.53 | 19.31 |
| | | | | 1 | 1967.31 | 70.26 | 14251.81 | 57.24 |
| | | | | 1.5 | 2727.64 | 97.42 | 19397.97 | 77.90 |
| | | | | 2 | 2796.07 | 99.86 | 19267.12 | 77.38 |

### Exemplary Embodiment 5: Conversion to Lithium Solution after Lithium Ion Separation (Sulfuric Acid Leaching)

For the conversion from Li—Al LDH to a lithium solution, leaching was carried out at 80° C. for 12 hours under stirring at 300 RPM using 2˜5 M sulfuric acid solution to obtain a high-concentration lithium solution.

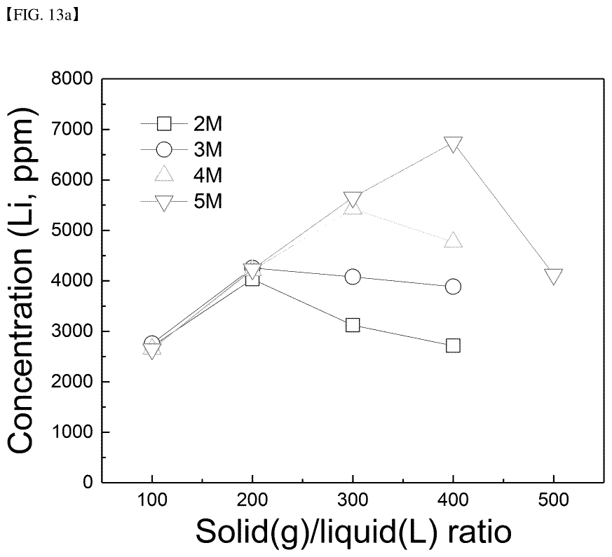

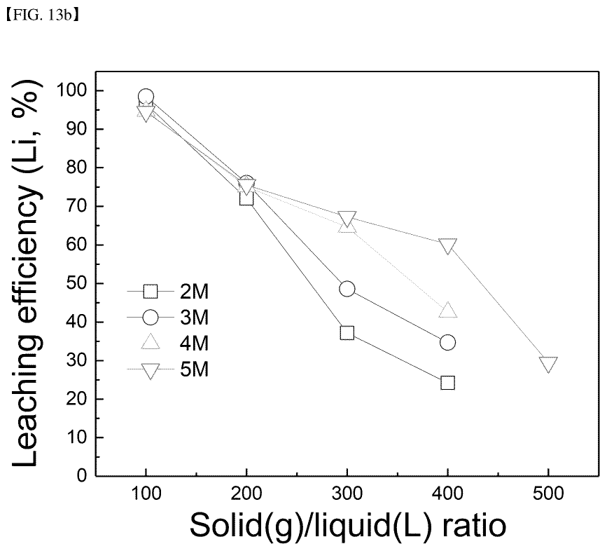

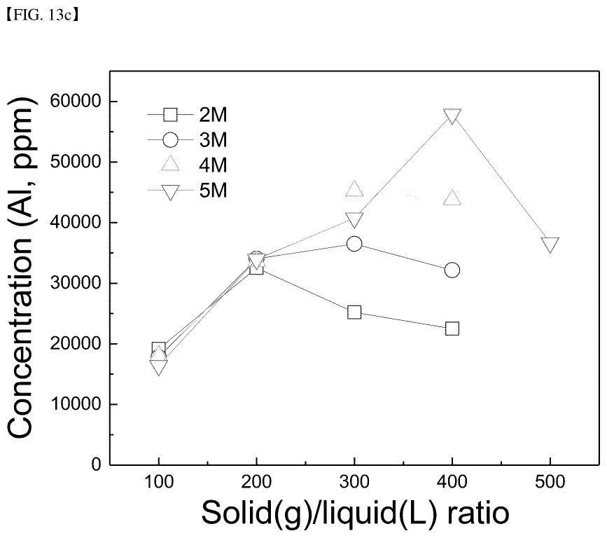

The sulfuric acid leaching experiment was conducted under conditions in which the solid-to-liquid (S/L) ratio of Li—Al LDH to sulfuric acid solution ranged from 100 to 500 (g/L). The results of the experiment are shown in Table 12 and FIGS. 13a to 13c.

From the experimental results, the maximum lithium leaching rate was observed under the condition of a 3 M sulfuric acid solution with an S/L ratio of 100. When the S/L ratio was increased to 200 or higher, the leaching rate tended to decrease.

Although the lithium ion concentration in the leachate increased with the molarity of the sulfuric acid solution and the S/L ratio, the leaching efficiency decreased as the S/L ratio increased for each acid concentration. Notably, the maximum leaching efficiency for each acid molarity was observed at an S/L ratio of 100.

This is presumed to be due to a reverse reaction induced by the increased concentrations of lithium and aluminum ions in the leachate during the sulfuric acid leaching of Li—Al LDH, thereby reducing the overall leaching efficiency.

TABLE 12

| | | | | Li | Al |
|---|---|---|---|---|---|
| H₂SO₄ | S/L Ratio | Li conc. | Al conc. | Leaching | Leaching |
| conc. (M) | (g/L) | (ppm) | (ppm) | Rate (%) | Rate (%) |
| 2 | 100 | 2702.66 | 19144.22 | 96.52 | 76.88 |
| | 200 | 4033.48 | 32511.59 | 72.03 | 65.28 |
| | 300 | 3122.14 | 25206.37 | 37.17 | 33.74 |
| | 400 | 2713.62 | 22489.99 | 24.23 | 22.58 |
| 3 | 100 | 2757.25 | 17804.39 | 98.47 | 71.50 |
| | 200 | 4255.52 | 34031.03 | 75.99 | 68.34 |
| | 300 | 4080.28 | 36497.58 | 48.57 | 48.86 |
| | 400 | 3883.94 | 32152.25 | 34.68 | 32.28 |
| 4 | 100 | 2651.14 | 18015.84 | 94.68 | 72.35 |
| | 200 | 4207.68 | 33647.17 | 75.14 | 67.56 |
| | 300 | 5430.07 | 45248.34 | 64.64 | 60.57 |
| | 400 | 4771.49 | 43802.99 | 42.60 | 43.98 |
| 5 | 100 | 2646.92 | 16388.78 | 94.53 | 65.82 |
| | 200 | 4230.38 | 33942.10 | 75.54 | 68.16 |
| | 300 | 5651.63 | 40742.82 | 67.28 | 54.54 |
| | 400 | 6741.94 | 57869.11 | 60.20 | 58.10 |
| | 500 | 4125.12 | 36648.27 | 29.47 | 29.44 |

### Exemplary Embodiment 6: Separation of Lithium Ions from Lithium Leachate (Sulfuric Acid Leaching)

The lithium leachate obtained through sulfuric acid leaching of Li—Al LDH contains an excessive amount of aluminum (Al), which is required to be removed during the lithium recovery process.

To separate impurities such as aluminum, a co-precipitation method using calcium hydroxide (Ca(OH)₂) was applied. This is because, when using pH adjustment via sodium hydroxide (NaOH), both lithium and aluminum ions in the leachate are subjected to reverse reaction into Li—Al LDH as the pH increases.

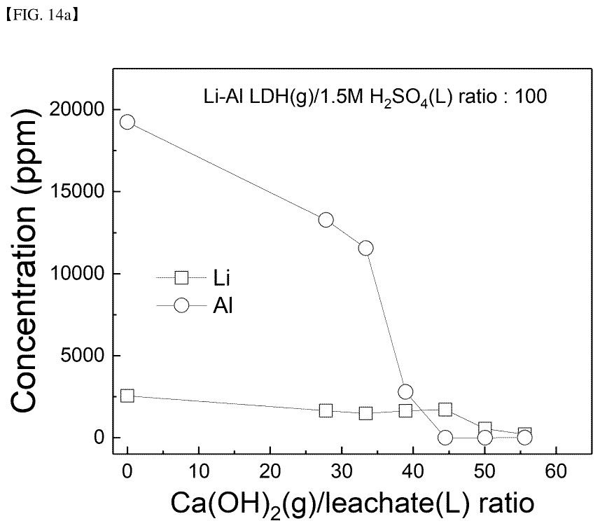

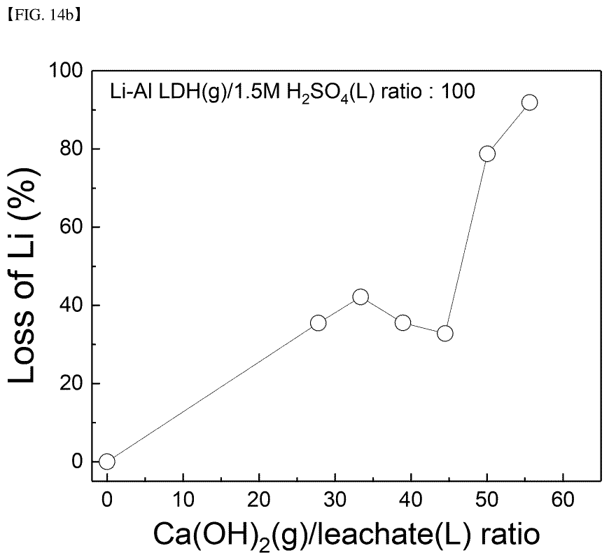

Specifically, a leachate was prepared by leaching Li—Al LDH (g) at a solid-to-liquid (g/L) ratio of 100 in 1.5 M sulfuric acid (L) at 80° C. for 8 hours. To this leachate, Ca(OH)₂ was added, and the mixture was stirred at 300 RPM at room temperature for 24 hours. The effect of Ca(OH)₂ addition on the concentrations of lithium and aluminum in the filtrate was analyzed. The titration reaction was performed using 50 mL of leachate while increasing the solid-to-liquid (g/L) ratio of Ca(OH)₂ to leachate. The experimental results are shown in Table 13, FIG. 14a, and FIG. 14b.

From the experimental results, it was confirmed that as the Ca(OH)₂-to-leachate (g/L) ratio increased, the concentration of aluminum ions decreased. However, it was also observed that the loss of lithium ions occurred in parallel. When aluminum ions were completely removed, the remaining lithium in the filtrate exhibited a loss rate of approximately 32%.

TABLE 13

| | Leachate | Ca(OH)₂ | Li | Al | Ca |
|---|---|---|---|---|---|
| Leaching | Volume | Weight | conc. | conc. | conc. |
| Condition | (mL) | (g) | (ppm) | (ppm) | (ppm) |
| Li—Al LDH(g)/ | 50 | | 2548.12 | 19240.88 | — |
| 1.5M H₂SO₄ | | 1.391 | 1644.43 | 13274.07 | 442.37 |
| (L):100, | | 1.669 | 1473.73 | 11551.43 | 425.99 |
| 80° C., 8 hours | | 1.947 | 1642.72 | 2789.15 | 376.92 |
| | | 2.2248 | 1712.67 | 0.00 | 404.41 |
| | | 2.503 | 541.53 | 0.00 | 409.46 |
| | | 2.781 | 207.02 | 6.36 | 478.67 |

### Exemplary Embodiment 7: Conversion to Lithium Solution after Lithium Ion Separation (Sulfuric Acid Roasting/Water Leaching)

In the process of producing a high-concentration lithium solution from Li—Al LDH, the recovery efficiency of lithium during sulfuric acid leaching is low, and the lithium ion concentration in the recovered solution is also low. Consequently, the conversion rate during the subsequent lithium carbonate precipitation process is limited. Furthermore, the recovered solution contains an excessive amount of aluminum, leading to lithium loss and excessive sludge formation in the downstream purification process.

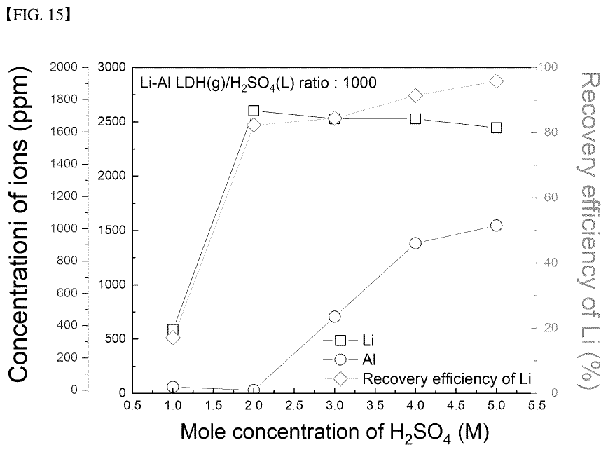

To increase the lithium ion concentration during the conversion of Li—Al LDH to a lithium solution and to suppress the incorporation of aluminum into the solution, roasting with sulfuric acid followed by water leaching was performed using sulfuric acid solutions of 1-5 M. The results are shown in Table 14 and FIG. 15.

Based on the experimental results, after sulfuric acid roasting at 300° C. for 1 hour under a solid-to-liquid (Li—Al LDH/sulfuric acid) ratio of 1000 (g/L), and subsequent water leaching at a solid-to-liquid (converted material/water) ratio of 100 (g/L), it was confirmed that aluminum incorporation could be suppressed at sulfuric acid concentrations of 2 M or lower, while at concentrations of 4 M or higher, aluminum incorporation occurred but the lithium recovery rate exceeded 90%.

TABLE 14
Water Leaching Experiment after Sulfuric Acid Roasting according to Sulfuric Acid Molar Concentration

| Sulfuric Acid | | Water Leaching Experiment of Sulfuric Acid Roasting Conversion Product | | | | | |
|---|---|---|---|---|---|---|---|
| Roasting Experiment | | | Stirring | Water | Li | Li | Al |
| Roasting | Sulfuric Acid | Reaction | Speed | Leaching | Concentra- | Recovery | Concentra- |
| Conditions | Molarity (M) | Time (h) | (RPM) | Conditions | tion (ppm) | Rate (%) | tion (ppm) |
| 300° C. 1 h, | 1 | 24 h | 300 | Converted | 586.54 | 17.05 | 10.19 |
| Li—Al LDH(g)/Sulfuric | 2 | | | Material(g)/ | 2602.68 | 82.34 | 0.000 |
| Acid(L) Ratio: 1000 | 3 | | | Water(L) | 2527.14 | 84.44 | 455.33 |
| | 4 | | | Ratio: 100 | 2527.46 | 91.44 | 910.33 |
| | 5 | | | | 2445.56 | 95.81 | 1020.65 |

### Exemplary Embodiment 8: Lithium Leaching from Sulfuric Acid Roasting Conversion Product of Li—Al LDH

As shown in Exemplary Embodiment 7, selective separation of lithium ions was observed when using a 2M sulfuric acid solution under a solid-to-liquid ratio of 1000, based on the analysis of lithium and aluminum contents in the leachate recovered after water leaching of the sulfuric acid roasting conversion product of Li—Al LDH.

However, when the concentration of the sulfuric acid solution increased to 3M or higher, the aluminum content was found to increase due to the incorporation of aluminum sulfate formed during the water leaching process after the reaction.

Although the selective separation of lithium ions was possible by adjusting the sulfuric acid concentration during the sulfuric acid roasting of Li—Al LDH, a limitation of low recovery yield was observed. To address this, aluminum sulfate formed under high sulfuric acid concentration was converted into aluminum oxide to suppress its incorporation during water leaching.

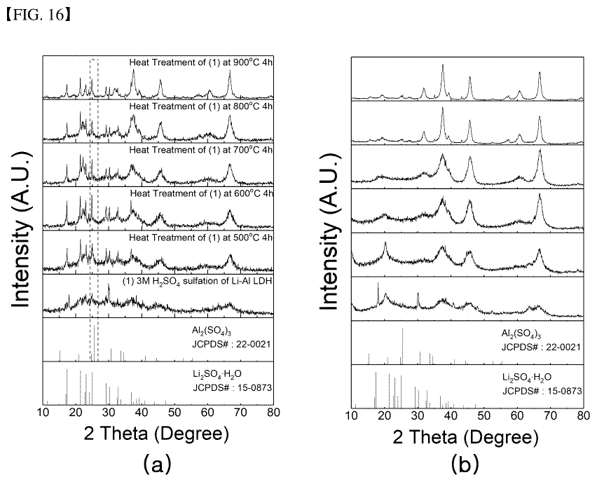

Li—Al LDH and sulfuric acid solution were mixed at a solid-to-liquid ratio of 1000 (g/L) and subjected to sulfuric acid roasting at 300° C. for 1 hour using 3M sulfuric acid. The resulting roasting conversion product was then heat-treated at various temperatures. The XRD analysis results before (a) and after (b) water leaching of the heat-treated product are shown in FIG. 16.

The results confirmed that the peak of aluminum sulfate disappeared at temperatures of approximately 600° C. or higher.

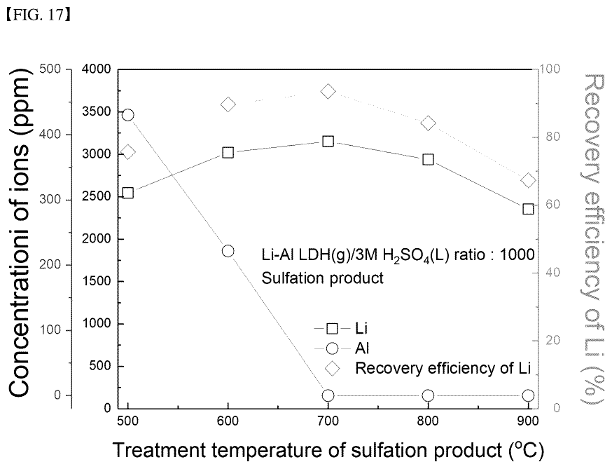

After sulfuric acid roasting of Li—Al LDH at 300° C. for 1 hour using 3M sulfuric acid solution at a solid-to-liquid ratio of 1000 (g/L), the roasted product was heat-treated at different temperatures, and water leaching was conducted at a solid-to-liquid (converted material/water) ratio of 100 (g/L). The concentrations of lithium and aluminum in the leachate were then analyzed. The results are shown in Table 15 and FIG. 17.

The results showed that heat treatment at 500° C. or higher led to a decrease in aluminum content in the leachate.

Furthermore, when the product roasted at 300° C. was heat-treated at 700° C. or higher and then subjected to water leaching, lithium was identified as the main component of the leachate. In contrast, aluminum was not detected due to its conversion into insoluble aluminum oxide.

It was also observed that sulfuric acid roasting at 700° C. resulted in reduced reactivity due to sulfuric acid loss, considering that the boiling point of sulfuric acid is 337° C. Therefore, it is deemed appropriate to perform sulfuric acid roasting of the Li—Al LDH and sulfuric acid mixture at 300° C. followed by heat treatment at 700° C. or higher.

TABLE 15
Results of water leaching after 3M sulfuric acid roasting, secondary heat treatment

| Sulfuric acid roasting/ | | | | | | | | |
|---|---|---|---|---|---|---|---|---|
| Heat treatment conditions | | | | | | | | |
| | | Secondary | Water leaching process | | | | | |
| Li—Al LDH | | Heat Treatment | | | Water | | | Li |
| Sulfuric Acid | Sample | Temperature | Reaction | Stirring | Leaching | | | Recovery |
| Roasting Condition | Weight | (° C.) | Time | Speed | Condition | Li | Al | Rate (%) |
| 3M H₂SO₄ | 4 g | 500 | 24 h | 300 | 3 g/ | 2545.437 | 430.225 | 75.749 |
| 300° C.-1 h | | 600 | | RPM | 30 mL | 3020.308 | 221.612 | 89.726 |
| 30 g/30 mL | | 700 | | | | 3154.179 | 0.000 | 93.578 |
| | | 800 | | | | 2938.821 | 0.000 | 84.209 |
| | | 900 | | | | 2354.868 | 0.000 | 67.337 |

### Exemplary Embodiment 9: Preparation of High-Concentration Lithium Solution from Sulfuric Acid Roasting Conversion Product of Li—Al LDH

A high-concentration lithium solution was prepared by repeatedly applying water leaching to the sulfuric acid roasting conversion product under the conditions of a solid-to-liquid (conversion product/water) ratio of 100 (g/L). The conversion product was obtained by sulfuric acid roasting using a 3M sulfuric acid solution under the conditions of a solid-to-liquid ratio (Li—Al LDH (g)/sulfuric acid solution (L)) of 1000.

In the preparation of the high-concentration lithium solution, the roasted conversion product was subjected to water leaching under a solid-to-liquid ratio (conversion product (g)/water (L)) of 100. The resulting solution (the leachate from the first water leaching cycle) was reused for subsequent leaching cycles, and the process was repeated up to the fifth cycle.

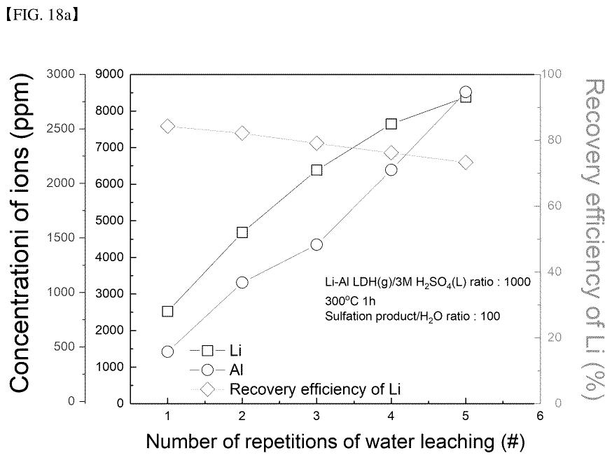

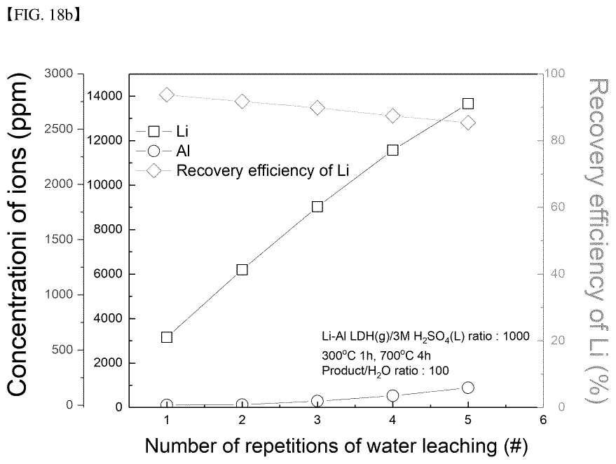

Referring to Table 16 and FIG. 18a, the lithium ion concentration and aluminum ion concentration in the final recovered solution were approximately 8376 ppm and 2839 ppm, respectively.

Furthermore, in order to suppress the incorporation of aluminum ions during sulfuric acid roasting/water leaching, the conversion product was subjected to secondary heat treatment at 700° C. for 4 hours after sulfuric acid roasting. Repeated water leaching was then performed up to the fifth cycle under the solid-to-liquid (conversion product/water) ratio of 100.

As shown in Table 17 and FIG. 18b, the lithium ion concentration and aluminum ion concentration in the final recovered solution were approximately 13664 ppm and 158 ppm, respectively.

The experimental results indicate that aluminum incorporation decreased after sulfuric acid roasting and secondary heat treatment, and the suppression of reformation into Li—Al LDH led to improved lithium ion recovery efficiency.

Moreover, performing secondary heat treatment at 700° C. or higher after sulfuric acid roasting increased the lithium content per unit weight, making it easier to produce high-concentration lithium solutions within the same number of water leaching cycles.

TABLE 16
Results of Repeated Water Leaching After 3M Sulfuric Acid Roasting

| Sulfuric Acid | | | | | | | |
|---|---|---|---|---|---|---|---|
| Roasting | | | | | | | |
| Li—Al LDH | Water Leaching Process | | | | | | |
| Sulfuric Acid | | | Water Leaching | | | | Li |
| Roasting | Reaction | Stirring | Condition | | | | Recovery |
| Conditions | Time | Speed | (Cycle, g/mL) | | Li | Al | Rate (%) |
| 3M H₂SO₄, | 24 h | 300 | 1st | 30/300 | 2521.97 | 456.54 | 84.26 |
| 300° C.-1 h, | | RPM | 2nd | 28/280 | 4678.81 | 1090.94 | 82.15 |
| 50 g/50 mL | | | 3rd | 25.8/258 | 6383.79 | 1438.58 | 79.09 |
| | | | 4th | 23.4/234 | 7644.56 | 2123.97 | 76.20 |
| | | | 5th | 21.2/212 | 8376.27 | 2839.08 | 73.27 |

TABLE 17
Results of Repeated Water Leaching After 3M Sulfuric Acid Roasting and Secondary Heat Treatment

| Sulfuric Acid Roasting/ | | | | | | | | | |
|---|---|---|---|---|---|---|---|---|---|
| Heat Treatment Condition | | | | | | | | | |
| | | Secondary | | | | | | | |
| Li—Al LDH | | Heat | Water Leaching Process | | | | | | |
| Sulfuric Acid | | Treatment | | | Water Leaching | | | | Li |
| Roasting | Sample | Temperature | Reaction | Stirring | Condition | | | | Recovery |
| Condition | Weight | (° C./h) | Time | Speed | (Cycle, g/mL) | | Li | Al | Rate (%) |
| 3M H₂SO₄ | 50 g | 700/4 | 24 h | 300 | 1st | 30/300 | 3159.45 | 3.25 | 93.77 |
| 300° C.-1 h | | | | RPM | 2nd | 28/280 | 6198.90 | 6.40 | 91.78 |
| 50 g/50 mL | | | | | 3rd | 26/260 | 9029.96 | 37.65 | 89.89 |
| | | | | | 4th | 23.8/238 | 11573.80 | 86.92 | 87.45 |
| | | | | | 5th | 21.8/218 | 13664.21 | 158.52 | 85.37 |

### Exemplary Embodiment 10: Application of Salt Roasting to Li—Al LDH

Salt roasting reactions were performed using chloride and sulfate compounds as reactants to obtain high-concentration lithium chloride and lithium sulfate solutions from Li—Al LDH.

A comparison was made of the lithium ion concentrations recovered after performing salt roasting and water leaching of Li—Al LDH(LiAl₂(OH)₇·2H₂O) with Me-Cl and Me-SO₄.

For the chloride-based salt roasting, CaCl₂, AlCl₃, and MgCl₂ were used, while for the sulfate-based salt roasting, Al₂(SO₄)₃·xH₂O (x:14˜18), MgSO₄, and (NH₄)₂SO₄ were employed. The molar ratio of Li/Cl was set to 1 for the chloride-based reactions, and the molar ratio of Li/SO₄ was set to 2 for the sulfate-based reactions. Each mixture was subjected to salt roasting for 4 hours at varying temperatures.

As shown in Table 18, the sulfate-based salt roasting using Me-SO₄ and subsequent water leaching yielded higher lithium ion concentrations compared to the chloride-based roasting process using Me-Cl and subsequent water leaching.

In addition, when using the sulfate compounds (Me-SO₄), the application of (NH₄)₂SO₄ at 700° C. for 4 hours resulted in the highest lithium ion concentration in the leachate.

TABLE 18
Li—Al LDH/Me-SO₄ or Me-Cl Salt Roasting (by temperature)

| | Salt | | | | | | |
|---|---|---|---|---|---|---|---|
| | Roasting | | Water Leaching (1 g/10 mL, 300 RPM, Room Temperature-24 h) | | | | |
| LDH/(Me-Cl or | Reaction | Sample | Li | Al | Ca | Mg | Na |
| Me-SO₄) | Conditions | Weight | conc. | conc. | conc. | conc. | conc. |
| Mixing Ratio | (° C.-h) | (g) | (ppm) | (ppm) | (ppm) | (ppm) | (ppm) |
| LDH + CaCl₂ | 500-4 | 4.003 | 1044.88 | 20.47 | 2395.01 | | |
| (Li/Ca = 2) | 600-4 | 4.009 | 1185.54 | 21.41 | 2424.91 | | |
| Ball milling | 700-4 | 4.007 | 1486.19 | 22.58 | 2161.33 | | |
| | 800-4 | 3.007 | 893.33 | 23.67 | 1534.69 | | |
| | 900-4 | 3.002 | 187.81 | 101.11 | 126.72 | | |
| LDH + AlCl₃ | 500-4 | 4.008 | 1313.24 | 3.01 | | | |
| (Li/Al = 3) | 600-4 | 4.009 | 1358.94 | 3.34 | | | |
| Ball milling | 700-4 | 4.006 | 1451.78 | 6.47 | | | |
| | 800-4 | 4.001 | 599.60 | 3.73 | | | |
| | 900-4 | 4.003 | 85.34 | 2.95 | | | |
| LDH + MgCl₂ | 500-4 | 4.008 | 1535.19 | 4.46 | | N.D. | |
| (Li/Mg = 2) | 600-4 | 4.006 | 1636.82 | 6.10 | | N.D. | |
| Ball milling | 700-4 | 4.007 | 1897.82 | 7.32 | | N.D. | |
| | 800-4 | 3.005 | 821.64 | 4.83 | | N.D. | |
| | 900-4 | 3.006 | 104.06 | 13.88 | | N.D. | |
| LDH + Al₂(SO₄)₃ | 500-4 | 4.007 | 1907.92 | N.D. | | | |
| (Li/Al = 3) | 600-4 | 4.008 | 2216.34 | N.D. | | | |
| Ball milling | 700-4 | 4.004 | 2614.98 | N.D. | | | |
| | 800-4 | 3.005 | 2036.15 | N.D. | | | |
| | 900-4 | 3.005 | 1791.46 | N.D. | | | |
| LDH + MgSO₄ | 500-4 | 4.005 | 861.81 | | | 2867.43 | |
| (Li/Mg = 2) | 600-4 | 4.008 | 1602.64 | | | 1874.61 | |
| Ball milling | 700-4 | 4.009 | 2226.30 | | | 936.94 | |
| | 800-4 | 3.006 | 2220.75 | | | 495.19 | |
| | 900-4 | 3.007 | 2199.30 | | | 101.30 | |
| LDH + Na₂SO₄ | 500-4 | 4.006 | 425.77 | 16.00 | | | 7288.26 |
| (Li/Na = 1) | 600-4 | 4.004 | 376.15 | 5.94 | | | 7929.00 |
| Ball milling | 700-4 | 4.009 | 365.28 | 35.65 | | | 8151.27 |
| | 800-4 | 3.005 | 380.19 | 13.67 | | | 7683.75 |
| | 900-4 | 3.005 | 542.81 | 91.47 | | | 7988.55 |
| LDH + (NH₄)₂SO₄ | 500-4 | 4.003 | 1968.34 | 114.52 | | | |
| (Li/NH₄ = 1) | 600-4 | 4.003 | 2527.89 | N.D. | | | |
| Ball milling | 700-4 | 4.005 | 2928.02 | N.D. | | | |
| | 800-4 | 3.002 | 2304.35 | N.D. | | | |
| | 900-4 | 3.007 | 1997.41 | N.D. | | | |

### Exemplary Embodiment 11: Preparation of Lithium Phosphate

In the preparation of high-concentration lithium solution for lithium carbonate synthesis from Li—Al LDH, the sulfuric acid leaching method requires a reaction with a high-concentration sulfuric acid solution under low solid-to-liquid (g/L) ratio conditions. However, this method has limitations due to the relatively low lithium ion concentration in the recovered solution and the high amount of co-leached aluminum, which leads to excessive sludge generation and lithium loss during subsequent purification steps.

In contrast, the sulfuric acid roasting and water leaching method enables the production of a high-concentration lithium solution with more than 1% lithium ion content, but it requires repeated leaching processes and a high solid-to-liquid (g/L) ratio for water leaching.

To address these issues, the present disclosure proposes a method for converting a lithium solution containing approximately 3000 ppm of lithium ions, obtained by leaching Li—Al LDH with dilute sulfuric acid, into an insoluble lithium compound such as lithium phosphate, followed by the regeneration of a high-concentration lithium solution via a wet process.

Specifically, Li—Al LDH was subjected to sulfuric acid roasting using 3M H₂SO₄ under the condition of a solid-to-liquid ratio (g/L) of 1000, followed by heat treatment at 700° C. for 4 hours to suppress the incorporation of aluminum sulfate. The conversion product was then water leached under a solid-to-liquid (conversion product/water) ratio of 100 (g/L), resulting in a lithium solution with a lithium ion concentration of approximately 3159 ppm.

Afterwards, to produce a higher-concentration lithium solution, the lithium in the recovered solution was converted into lithium phosphate (Li₃PO₄, 17.9%), an intermediate with a lithium content (17.9%) higher than that of Li—Al LDH (3.2%).

For the conversion to lithium phosphate, NaOH and H₃PO₄ were added to the solution to adjust the Li/PO₄ and Na/PO₄ molar ratios to 3. A precipitation reaction was carried out at a stirring speed of 300 RPM for 24 hours.

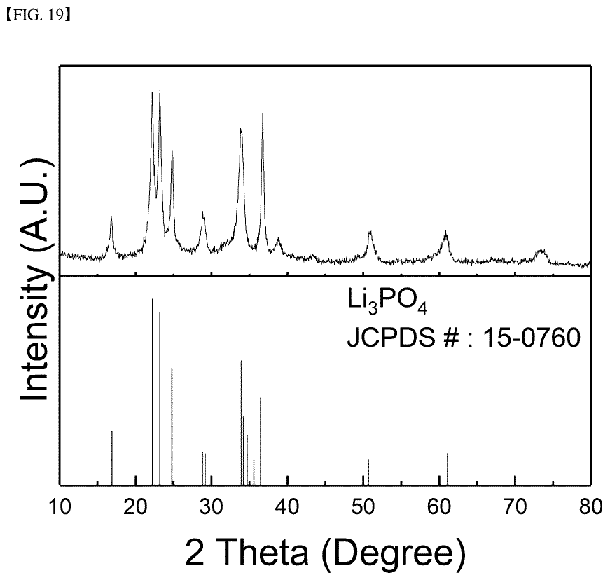

The resulting precipitate was then separated, filtered, washed, and dried to recover lithium phosphate, as shown in FIG. 19.

### Exemplary Embodiment 12: Preparation of Lithium Sulfate

The preparation of lithium carbonate typically involves precipitating it as a poorly soluble compound by reacting a high-concentration lithium solution (>1%) with a carbonate. To enhance the efficiency of lithium carbonate production, a high-concentration lithium solution is required. In the present disclosure, a wet substitution reaction using sulfate-based compounds (Me-SO₄) was applied to produce a high-concentration lithium sulfate solution.

Sulfate-based compounds such as MgSO₄, (NH₄)₂SO₄, and Al₂(SO₄)₃ were used, and the conversion reaction was conducted at 80° C. under a Li/SO₄ molar ratio of 2.

Each sulfate compound was dissolved in distilled water, and lithium phosphate was added under a solid-to-liquid ratio of 100 (g/L). To prevent the evaporation of the aqueous solution during the reaction, a reflux apparatus was employed to proceed the conversion reactions.

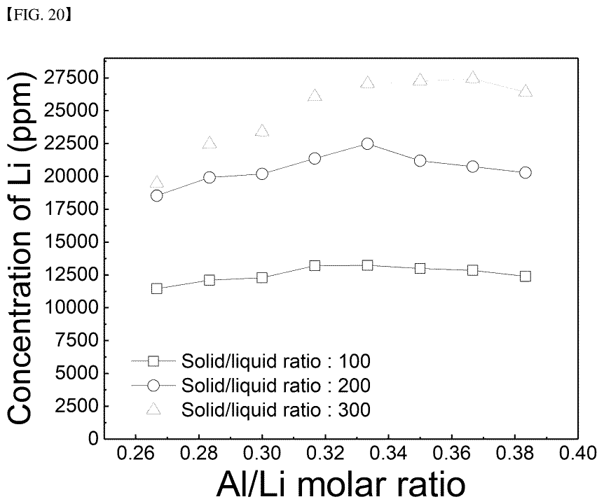

As shown in Table 19 and FIG. 20, among the tested conditions with a solid-to-liquid ratio of 100, the use of Al₂(SO₄)₃ yielded the highest lithium ion concentration in the resulting solution.

Furthermore, when Al₂(SO₄)₃ was used, the solid-to-liquid ratio of the lithium phosphate to the sulfate solution was varied from 100 to 300, and the wet substitution reaction was conducted at 80° C. The results showed that lithium ion concentrations increased under Al/Li molar ratios ranging from 0.317 to 0.367, depending on the solid-to-liquid ratio. Specifically, at solid-to-liquid ratios of 100 and 200, the lithium ion concentration peaked at the stoichiometric Al/Li molar ratio of 0.333, while at a solid-to-liquid ratio of 300, the highest peak lithium ion concentration was observed at an Al/Li molar ratio of 0.367.

TABLE 19
Conversion of Li₃PO₄ to Li₂SO₄ Solution

| Experimental Conditions | | | | | | |
|---|---|---|---|---|---|---|
| | | Solid-to- | | | | |
| | Molar | Liquid | Stirring | Reaction | | Concentra- |
| Sulfate | ratio | Ratio | Speed | Temperature/ | Sample | tion (ppm) |
| source | (Li/Metal) | (g/L) | (r.p.m.) | Time | Name | Li |
| MgSO₄ | 2/1 | 100/1 | 300 | 80° C., 8 hr | Initial | |
| | | | | | Final | 7993.99 |
| (NH₄)₂SO₄ | 1/1 | 100/1 | 300 | 80° C., 8 hr | Initial | |
| | | | | | Final | 2796.43 |
| Al₂(SO₄)₃ | 3/1 | 100/1 | 300 | 80° C., 8 hr | Initial | |
| | | | | | Final | 13224.2 |

### Exemplary Embodiment 13: Preparation of Lithium Carbonate

A lithium-containing leachate (Li: 13,664 ppm, Al: 158 ppm) was prepared by conducting five cycles of water leaching (solid-to-liquid ratio: 100) using the conversion product obtained from sulfuric acid roasting of Li—Al LDH (3M H₂SO₄, 300° C. for 1 hour, 50 g/50 mL) followed by heat treatment at 700° C. for 4 hours. The results are shown in Table 20 below.

Subsequently, 200 mL of the lithium-containing leachate (Li: 13,664 ppm, Al: 158 ppm) was treated by adding Ca(OH)₂ to achieve a Ca/Al molar ratio of 1, followed by stirring for 12 hours to separate aluminum ions. The composition of the reaction filtrate is shown in Table 21.

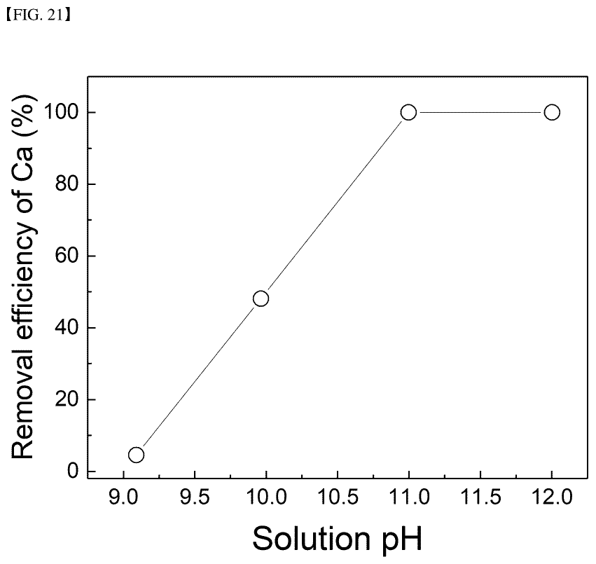

After filtration and separation of the resulting precipitate, NaOH solution was added to the remaining solution to adjust the pH to 11 in order to remove residual Ca ions, and the mixture was stirred for an additional 12 hours. The composition of the resulting filtrate is provided in Table 22. The efficiency of Ca ion removal at different pH values is illustrated in FIG. 21.

The lithium-containing leachate, after removal of Al and Ca ions, was reacted with Na₂CO₃ at a Li/CO₃ molar ratio of 2 to synthesize lithium carbonate. The composition of the obtained lithium carbonate is listed in Table 23.

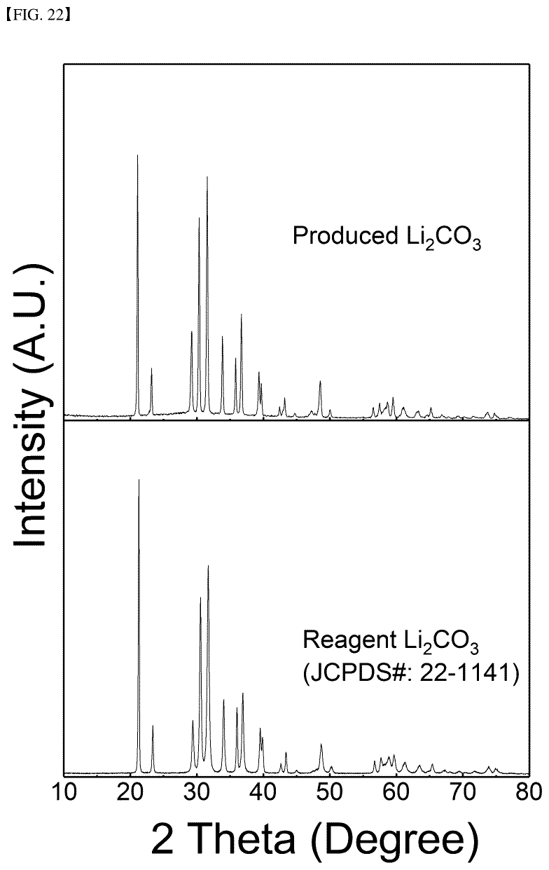

The resulting lithium carbonate (Li₂CO₃) was further subjected to hot water washing using 2 L of water at 80° C. to remove residual Na ions from the surface. The XRD pattern of the produced lithium carbonate is shown in FIG. 22.

TABLE 20
Water Leaching Results after 3M Sulfuric Acid
Roasting and Secondary Heat Treatment (5 times)

| Water Leaching | Solid-to- | Stirring | Li | Al | |
|---|---|---|---|---|---|
| Condition | Liquid Ratio | Speed | conc. | conc. | |
| (° C.-h) | (g/L) | (RPM) | (ppm) | (ppm) | pH |
| Room Tem- | 100 | 300 | 13664.22 | 158.53 | 2.39 |
| perature-24 | | | | | |

TABLE 21
Primary Purification of Leachate after 3M Sulfuric Acid Roasting/Secondary
Heat Treatment/Water Leaching (using Ca(OH)₂)

| Leachate | | Leaching | Stirring | | Li | Al | Ca | |
|---|---|---|---|---|---|---|---|---|
| Volume | Purification | Condition | Speed | Reaction | conc. | conc. | conc. | |
| (mL) | Condition | (° C.-h) | (RPM) | Time | (ppm) | (ppm) | (ppm) | pH |
| 200 | Ca/Al molar | Room | 300 | Initial | 13664.22 | 158.53 | — | 2.39 |
| | ratio:1 | Temper- | | Final | 13347.68 | — | 201.48 | 4.21 |
| | | ature-24 | | | | | | |

TABLE 22
Secondary Purification of Leachate after 3M Sulfuric Acid Roasting/Secondary
Heat Treatment/Water Leaching (using NaOH)

| Leachate | | Leaching | Stirring | | Li | Al | Ca | Na | |
|---|---|---|---|---|---|---|---|---|---|
| Volume | Purification | Condition | Speed | Reaction | conc. | conc. | conc. | conc. | |
| (mL) | Condition | (° C.-h) | (RPM) | Time | (ppm) | (ppm) | (ppm) | (ppm) | pH |
| 180 | pH 11> | Room | 300 | Initial | 13347.68 | — | 201.48 | 321.12 | 4.21 |
| | | Temper- | | Final | 13087.15 | — | — | 31269.75 | 11.08 |
| | | ature-24 | | | | | | | |

TABLE 23
Lithium Carbonate Preparation

| Leachate | | Production | Stirring | | Li | Al | Ca | Na | |
|---|---|---|---|---|---|---|---|---|---|
| Volume | Production | Condition | Speed | Reaction | conc. | conc. | conc. | conc. | |
| (mL) | Condition | (° C.-h) | (RPM) | Time | (ppm) | (ppm) | (ppm) | (ppm) | pH |
| 150 | Li/CO₃ molar | 80-24 | 300 | Initial | 13087.15 | — | — | 31269.75 | 11.08 |
| | ratio:2 | | | Final | 1896.12 | — | — | 57541.66 | 11.59 |

### INDUSTRIAL APPLICABILITY

The method for recovering high-efficiency lithium from a low-concentration lithium waste liquid according to the present disclosure enables the recovery of valuable lithium ions from low-concentration lithium waste liquids that have conventionally been treated as wastewater, and provides an environmentally friendly and highly efficient lithium recovery technology by reducing the use of precipitants and alkaline agents.

1. A method for recovering high-efficiency lithium from a low-concentration lithium waste liquid, comprising:
a step (S10) of adsorbing lithium-containing metal ions from a lithium waste liquid onto an electrode in an electric adsorption system, and desorbing the metal ions adsorbed on the electrode with a desorption solution, wherein the lithium waste liquid has a lithium content of 100 ppm or less;
a step (S20) of preparing an insoluble lithium compound by adding an aluminum source to the desorption solution;
a step (S30) of preparing a leachate by acid leaching or roasting/water leaching of the insoluble lithium compound;
a step of heat-treating the roasted insoluble lithium compound; and
a step (S40) of producing at least one selected from the group consisting of lithium phosphate, lithium sulfate, and lithium carbonate from the leachate,
wherein, in step (S10), lithium ion concentration in the desorption solution ranges from 500 to 1000 ppm,
wherein, in step (S20), the insoluble lithium compound is Li—Al-LDH(LiAl₂(OH)₇·2H₂O),
wherein, in step (S30), a 1.5 M sulfuric acid solution is used in the acid leaching, and wherein the heat-treating step is performed at a temperature of 700° C.

2. (canceled)

3. The method of claim 1,
wherein, in step S10, the adsorption and the desorption are performed in an alternating manner, once or 2 to 20 times repeatedly under a potential of 1 V to 2 V, and
wherein a residual solution remaining on the electrode is removed between the adsorption and the desorption and after the desorption.

4. The method of claim 1,
wherein the aluminum source includes at least one selected from the group consisting of aluminum, sodium aluminate, aluminum hydroxide, alumina, aluminum chloride, and aluminum sulfate.

5. The method of claim 1,
wherein, in step S20, the aluminum source is added to the desorption solution and reacted such that a molar ratio of Al to Li ranges from 1 to 4, to precipitate the insoluble lithium compound.

6. The method of claim 1,
wherein, when the leachate is prepared by the acid leaching of the insoluble lithium compound,
the insoluble lithium compound and a sulfuric acid solution are mixed and reacted such that a solid-to-liquid ratio (g/L) of the insoluble lithium compound to the sulfuric acid solution ranges from 50 to 500,
and a molar concentration of the sulfuric acid solution ranges from 0.5 M to 5 M.

7. The method of claim 1,
wherein, when the leachate is prepared by the roasting/water leaching of the insoluble lithium compound,
the roasting performed prior to the water leaching is sulfuric acid roasting or salt roasting.

8. The method of claim 7,
wherein, when the sulfuric acid roasting is performed,
the insoluble lithium compound and a sulfuric acid solution are mixed such that a solid-to-liquid ratio (g/L) of the insoluble lithium compound to the sulfuric acid solution ranges from 100 to 2000, and reacted at a temperature of 200° C. to 400° C. for 30 minutes to 2 hours to produce a sulfuric acid roasting conversion product,
and a molar concentration of the sulfuric acid solution ranges from 1 M to 5 M.

9. The method of claim 8,
wherein the sulfuric acid roasting conversion product is heat-treated at a temperature of 600° C. to 1000° C. for 1 hour to 5 hours prior to the water leaching.

10. The method of claim 7,
wherein, when the salt roasting is performed, at least one reactant selected from the group consisting of chlorides (Me-Cl) and sulfates (Me-SO₄) is mixed with the insoluble lithium compound,
wherein, when a chloride is used as the reactant, a molar ratio of Li to Cl is adjusted to range from 0.5 to 1.5,
wherein, when a sulfate is used as the reactant, a molar ratio of Li to SO₄ is adjusted to range from 1.6 to 2.5, and
wherein the reactant mixed with the insoluble lithium compound is reacted at a temperature of 500° C. to 900° C. for 3 hours to 5 hours.

11. The method of claim 1,
wherein the water leaching is performed once or 2 to 10 times repeatedly.

12. The method of claim 1,
wherein step S40 includes:
a step (S41) of producing lithium phosphate from the leachate;
a step (S42) of producing a lithium sulfate solution from the lithium phosphate; and
a step (S43) of producing lithium carbonate from the lithium sulfate solution.

13. The method of claim 12,
wherein, in step S41, a phosphate source and a sodium source are added to the leachate such that a molar ratio of Li to PO₄ ranges from 2 to 4 and a molar ratio of Na to PO₄ ranges from 2 to 4, and the leachate mixed with the phosphate source and the sodium source is reacted for 4 hours to 30 hours.

14. The method of claim 12,
wherein, in step S42, the lithium phosphate is mixed with a sulfate (Me-SO₄) solution dissolved in distilled water and reacted such that a molar ratio of Li to SO₄ ranges from 1 to 3 and a solid-to-liquid ratio (g/L) of the lithium phosphate to the sulfate solution ranges from 80 to 320, to produce the lithium sulfate solution.

15. The method of claim 14,
wherein the sulfate includes at least one selected from the group consisting of MgSO₄, (NH₄)₂SO₄, and Al₂(SO₄)₃.

16. The method of claim 14,
wherein step S43 includes:
a step of removing impurities by adding an alkaline agent to the lithium sulfate solution; and
a step of producing the lithium carbonate by adding a carbonate source to the lithium sulfate solution from which the impurities have been removed.

17. The method of claim 16,
wherein, in the step of removing impurities by adding an alkaline agent to the lithium sulfate solution,
calcium hydroxide is added to the lithium sulfate solution to precipitate and remove aluminum, and
sodium hydroxide is added to adjust the pH to 11 or higher to remove calcium ions.

18. The method of claim 16,
wherein, in the step of producing the lithium carbonate by adding a carbonate source to the lithium sulfate solution from which the impurities have been removed,
the carbonate source is added such that a molar ratio of Li to CO₃ ranges from 1.5 to 2.5, and
the lithium carbonate is precipitated by stirring the mixture at a temperature of 40° C. to 90° C. for 1 hour to 24 hours.

19. The method of claim 16,
wherein the carbonate source includes at least one selected from the group consisting of sodium carbonate (Na₂CO₃), sodium bicarbonate (NaHCO₃), potassium carbonate (K₂CO₃), potassium bicarbonate (KHCO₃), calcium carbonate (CaCO₃), magnesium carbonate (MgCO₃), and barium carbonate (BaCO₃).

20. Lithium carbonate produced by the method of claim 1.
